(19) United States
(12) Patent Application Publication
(10) Pub. No.: US 2007/0047235 A1
(43) Pub. Date: Mar. 1, 2007

(54) Method and apparatus for providing light

(75) Inventor: Wailam Wilson, Tyrone, GA (US)

Correspondence Address: HAYNES AND BOONE, LLP, 901 MAIN STREET, SUITE 3100, DALLAS, TX, 75202, US

(73) Assignee: Cooper Technologies Company, Houston, TX (US)

(21) Appl. No.: 11/328,999

(22) Filed: Jan. 10, 2006

Related U.S. Application Data
(60) Provisional application No. 60/711,021, filed on Aug. 24, 2005.

(51) Int. Cl. F21V 7/00

(52) U.S. Cl. 362/341

(57) ABSTRACT

An apparatus and method according to which light is provided.

### CROSS REFERENCE TO RELATED APPLICATIONS

The present application claims priority to U.S. Provisional Application Ser. No. 60/711,021, attorney docket number 23667.111, filed on Aug. 24, 2005, the disclosure which is incorporated herein by reference.

The present application is related to U.S. Utility application Ser. No. ______, attorney docket number 23667.97, filed on Jan. 10, 2006, U.S. Utility application Ser. No. ______, attorney docket number 23667.98, filed on Jan. 10, 2006, and U.S. Utility application Ser. No. ______, attorney docket number 23667.190, filed on Jan. 10, 2006, the disclosures of which are incorporated herein by reference.

### BACKGROUND

The present disclosure relates in general to lighting and in particular to a method and apparatus for providing light.

### BRIEF DESCRIPTION OF THE DRAWINGS

FIG. 1aa is a perspective view illustrating an exemplary embodiment of a downlight cone.

FIG. 1ab is a perspective view illustrating an exemplary embodiment of the downlight cone of FIG. 1aa.

FIG. 1ba is a top view illustrating an exemplary embodiment of the downlight cone of FIG. 1aa.

FIG. 1bb is a top view illustrating an exemplary embodiment of the downlight cone of FIG. 1ba.

FIG. 2a is a perspective view illustrating an exemplary embodiment of a kicker reflector used with the downlight cone of FIG. 1aa.

FIG. 2b is a top view illustrating an exemplary embodiment of the kicker reflector of FIG. 2a.

FIG. 3 is a perspective view illustrating an exemplary embodiment of a lighting device used with the downlight cone of FIG. 1aa and the kicker reflector of FIG. 2a.

FIG. 4a is a perspective view illustrating an exemplary embodiment of a lighting apparatus including the downlight cone of FIGS. 1aa, 1ab, 1ba, and 1bb, the kicker reflector of FIGS. 2a and 2b, and the lighting device of FIG. 3.

FIG. 4b is a cross sectional view illustrating an exemplary embodiment of the lighting apparatus of FIG. 4a.

FIG. 5a is a flow chart illustrating an exemplary embodiment of a method for providing light.

FIG. 5b is a perspective view illustrating an exemplary embodiment of the lighting apparatus of FIG. 4a producing a wash beam pattern on a wall.

FIG. 5c is a perspective view illustrating an exemplary embodiment of the lighting apparatus of FIG. 4a producing a scallop beam pattern on a wall.

FIG. 5d is a perspective view illustrating an exemplary embodiment of the lighting apparatus of FIG. 4a producing a trapezoidal beam pattern on a wall.

FIG. 6a is a perspective view illustrating an exemplary embodiment of a plurality of the lighting apparatus of FIG. 4a producing a plurality of wash beam patterns on a wall.

FIG. 6b is a plot illustrating an exemplary experimental embodiment of the illuminance of the lighting apparatus of FIG. 4a using the lighting system of FIG. 6a superimposed over the luminance of a conventional lighting apparatus used in a conventional lighting system.

FIG. 6c is a plot illustrating an exemplary experimental embodiment of the illuminance of a conventional lighting system including a plurality of conventional lighting apparatus.

FIG. 6d is a plot illustrating an exemplary experimental embodiment of the illuminance of the lighting system of FIG. 6a.

FIG. 7 is a perspective view illustrating an exemplary embodiment of a lighting apparatus.

FIG. 8a is a plan view illustrating an exemplary embodiment of the operation of the lighting apparatus of FIG. 7.

FIG. 8b is a perspective view illustrating an exemplary embodiment of the operation of lighting apparatus of FIG. 7.

FIG. 9a is a partial cross sectional view illustrating an exemplary embodiment of a lighting apparatus.

FIG. 9b is a bottom view illustrating an exemplary embodiment of the lighting apparatus of FIG. 9a.

FIG. 10a is a cross sectional view illustrating an exemplary embodiment of a conventional asymmetrical lighting apparatus.

FIG. 10b is a bottom view illustrating an exemplary embodiment of the conventional asymmetrical lighting apparatus of FIG. 10a

FIG. 10c is a iso-footcandle graph illustrating an exemplary embodiment of the operation of a conventional asymmetrical lighting apparatus of FIGS. 10a and 10b.

FIG. 10d is a efficiency graph illustrating an exemplary embodiment of the operation of a conventional asymmetrical lighting apparatus of FIGS. 10a and 10b.

FIG. 11a is a iso-footcandle graph illustrating an experimental embodiment of the operation of the lighting apparatus of FIGS. 9a and 9b.

FIG. 11b is a efficiency graph illustrating an exemplary embodiment of the operation of the lighting apparatus of FIGS. 9a and 9b.

FIG. 12a is a perspective view illustrating an exemplary embodiment of a concave reflector.

FIG. 12b is a cross sectional view illustrating an exemplary embodiment of the concave reflector of FIG. 12a.

FIG. 13 is a side view illustrating an exemplary embodiment of a light source used with the concave reflector of FIGS. 12a and 12b.

FIG. 14a is a partial cross sectional view illustrating an exemplary embodiment of a conventional light providing apparatus including the concave reflector of FIGS. 12a and 12b and the light source of FIG. 13.

FIG. 14b is a bottom view illustrating an exemplary embodiment of the conventional light providing apparatus of FIG. 14a.

FIG. 14c is a bottom view illustrating an exemplary embodiment of a plurality of distances defined by the conventional light providing apparatus of FIGS. 14a and 14b.

FIG. 14d is a cross sectional view illustrating an exemplary embodiment of a plurality of distances defined by the conventional light providing apparatus of FIGS. 14a and 14b.

FIG. 14e is a candela graph illustrating an exemplary embodiment of the operation of the conventional light providing apparatus of FIGS. 14a and 14b.

FIG. 14f is an isofootcandle graph illustrating an exemplary embodiment of the operation of the conventional light providing apparatus of FIGS. 14a and 14b.

FIG. 15a is a candela graph illustrating an exemplary embodiment of the operation of the conventional light providing apparatus of FIGS. 14a and 14b after it has been modified by a plurality of conventional inserts in order to provide an asymmetric light pattern.

FIG. 15b is an isofootcandle graph illustrating an exemplary embodiment of the operation of the conventional light providing apparatus of FIGS. 14a and 14b after it has been modified by a plurality of conventional inserts in order to provide an asymmetric light pattern.

FIG. 15c is an efficiency graph illustrating an exemplary embodiment of the efficiency of the conventional light providing apparatus of FIGS. 14a and 14b after it has been modified by a plurality of conventional inserts in order to provide an asymmetric light pattern.

FIG. 16a is a partial cross sectional view illustrating an exemplary embodiment of a light providing apparatus including the light source of FIG. 13 positioned in the concave reflector of FIGS. 12a and 12b.

FIG. 16b is a bottom view illustrating an exemplary embodiment of the light providing apparatus of FIG. 16a.

FIG. 16c is a bottom view illustrating an exemplary embodiment of a light source coupling device used with the light providing apparatus of FIGS. 16a and 16b.

FIG. 16d is a candela graph illustrating an exemplary embodiment of the operation of the light providing apparatus of FIGS. 16a and 16b.

FIG. 16e is an isofootcandle graph illustrating an exemplary embodiment of the operation of the light providing apparatus of FIGS. 16a and 16b.

FIG. 17a is a partial cross sectional view illustrating an exemplary embodiment of a light providing apparatus including the light source of FIG. 13 positioned in the concave reflector of FIGS. 12a and 12b.

FIG. 17b is a bottom view illustrating an exemplary embodiment of the light providing apparatus of FIG. 17a.

FIG. 17c is a bottom view illustrating an exemplary embodiment of a light source coupling device used with the light providing apparatus of FIGS. 17a and 17b.

FIG. 17d is a candela graph illustrating an exemplary embodiment of the operation of the light providing apparatus of FIGS. 17a and 17b.

FIG. 17e is an isofootcandle graph illustrating an exemplary embodiment of the operation of the light providing apparatus of FIGS. 17a and 17b.

FIG. 18a is a partial cross sectional view illustrating an exemplary embodiment of a light providing apparatus including the light source of FIG. 13 positioned in the concave reflector of FIGS. 12a and 12b.

FIG. 18b is a bottom view illustrating an exemplary embodiment of the light providing apparatus of FIG. 18a.

FIG. 18c is a bottom view illustrating an exemplary embodiment of a light source coupling device used with the light providing apparatus of FIGS. 18a and 18b.

FIG. 18d is a candela graph illustrating an exemplary embodiment of the operation of the light providing apparatus of FIGS. 18a and 18b.

FIG. 18e is an isofootcandle graph illustrating an exemplary embodiment of the operation of the light providing apparatus of FIGS. 18a and 18b.

FIG. 19a is a partial cross sectional view illustrating an exemplary embodiment of a light providing apparatus including the light source of FIG. 13 positioned in the concave reflector of FIGS. 12a and 12b.

FIG. 19b is a bottom view illustrating an exemplary embodiment of the light providing apparatus of FIG. 19a.

FIG. 19c is a bottom view illustrating an exemplary embodiment of a light source coupling device used with the light providing apparatus of FIGS. 19a and 19b.

FIG. 19d is a candela graph illustrating an exemplary embodiment of the operation of the light providing apparatus of FIGS. 19a and 19b.

FIG. 19e is an isofootcandle graph illustrating an exemplary embodiment of the operation of the light providing apparatus of FIGS. 19a and 19b.

FIG. 20a is a partial cross sectional view illustrating an exemplary embodiment of the light providing apparatus of FIGS. 16a and 16b with a reflector and a plurality of inserts positioned in the concave reflector.

FIG. 20b is a bottom view illustrating an exemplary embodiment of the light providing apparatus of FIG. 20a.

FIG. 20c is a candela graph illustrating an exemplary embodiment of the operation of the light providing apparatus of FIGS. 20a and 20b.

FIG. 20d is an isofootcandle graph illustrating an exemplary embodiment of the operation of the light providing apparatus of FIGS. 20a and 20b.

FIG. 20e is an efficiency graph illustrating an exemplary embodiment of the efficiency of the light providing apparatus of FIGS. 20a and 20b.

### DETAILED DESCRIPTION

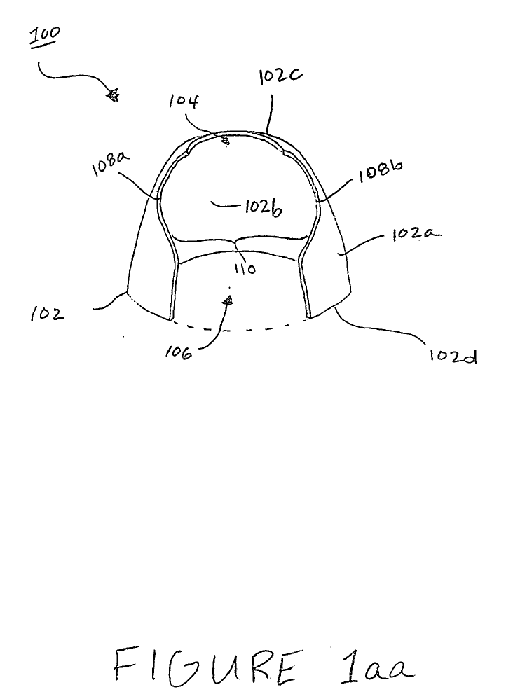

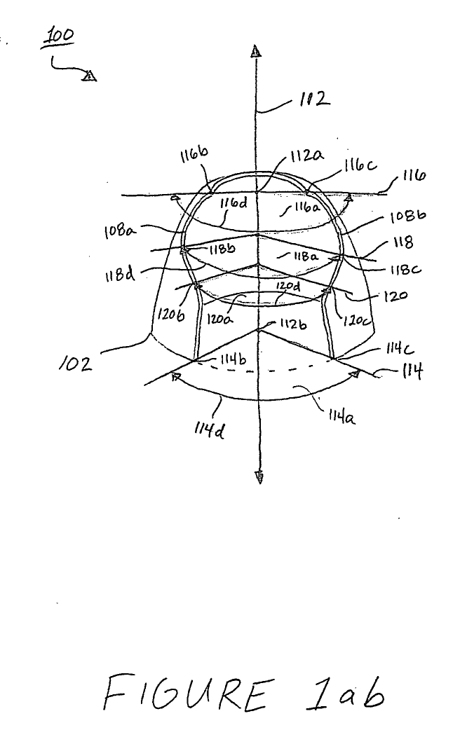

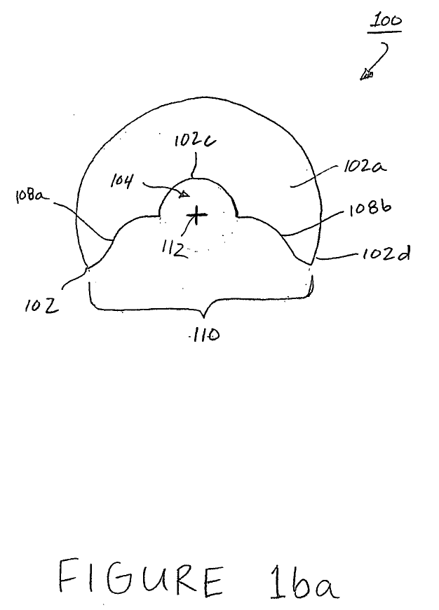

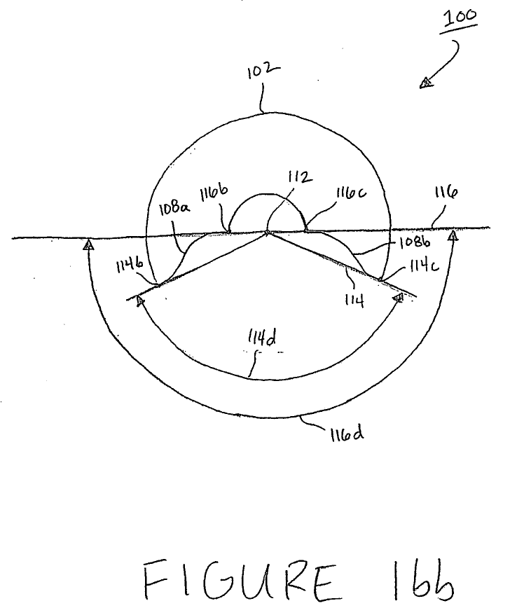

Referring now to FIGS. 1aa and 1ab, a downlight cone 100 is illustrated. The downlight cone 100 includes a base 102 having an outer surface 102a, an inner reflective surface 102b located opposite the outer surface 102a, a top surface 102c, and a bottom surface 102d located opposite the top surface 102c. A semi-circular lighting device channel 104 is defined by the base 102 and located adjacent the top surface 102c of the base 102. A semi-circular light passageway 106 is defined by the base 102 and located adjacent the bottom surface 102d of the base 102. A pair of symmetrical contours 108a and 108b extend between the top surface 102c and the bottom surface 102d and define a window cut 110 in the downlight cone 100 and between the symmetrical contours 108a and 108b.

Referring now to FIGS. 1aa, 1ab, 1ba, and 1bb, the downlight cone 100 defines a longitudinal axis 112 extending through the center of the downlight cone 100 such that the longitudinal axis 112 intersects a center 112a of the semi-circular lighting device channel 104 and a center 112b of the semicircular light passageway 106. A first zone 114 on the window cut 110 defines a first plane 114a through the center 112b of the semicircular light passageway 106 and a pair of symmetry points 114b and 114c on the symmetrical contours 108a and 108b, respectively, located adjacent the bottom surface 102d. The first zone 114 defines an first angle 114d between the symmetry points 114b and 114c with the longitudinal axis 112 as its vertice. A second zone 116 on the window cut 110 defines a second plane 116a, which is substantially parallel to the first plane 114a, through the center 112a of the semicircular lighting device channel 104 and a pair of symmetry points 116b and 116c on the symmetrical contours 108a and 108b, respectively, located adjacent the top surface 102c. The second zone 116 defines an second angle 116d between the symmetry points 116b and 116c with the longitudinal axis 112 as its vertice. A third zone 118 on the window cut 110 defines a third plane 118a, which is substantially parallel to the second plane 116a and the first plane 114a, through a pair of symmetry points 118b and 118c on the symmetrical contours 108a and 108b, respectively. The third zone 118 defines an third angle 118d between the symmetry points 118b and 118c with the longitudinal axis 112 as its vertice. A fourth zone 120 on the window cut 110 defines a fourth plane 120a, which is substantially parallel to the third plane 118a, the second plane 116a, and the first plane 114a, through a pair of symmetry points 120b and 120c on the symmetrical contours 108a and 108b, respectively. The fourth zone 120 defines a fourth angle 120d between the symmetry points 120b and 120c with the longitudinal axis 112 as its vertice.

In an exemplary embodiment, each of the first plane 114a, the third plane 118a, and the fourth plane 120a are a directional distance from the second plane 116a which is defined as the distance between the respective planes intersection with the longitudinal axis 112 and the center 112a of the semicircular lighting device channel 104, the directional distance which is parallel to the longitudinal axis 112. In an exemplary embodiment, a plurality of planes which are parallel to the first plane 114a, the second plane 116a, the third plane 118a, and the fourth plane 120a may be defined through the downlight cone 100, each defining an angle with its vertice at the longitudinal axis 112 and bounded by the planes intersection with the symmetrical contours 108a and 108b, whereby the size of each respective angle increases as the directional distance between any given plane and the second plane 116a decreases, as illustrated in FIG. 1ab. In an exemplary embodiment, the first angle 114d may range from approximately 90 degrees to approximately 130 degrees. In an exemplary embodiment, the second angle 116d is approximately 180 degrees. In an exemplary embodiment, the third angle 118d is greater than the fourth angle 120d and less than the second angle 116d. In an exemplary embodiment, the fourth angle 120d is greater than the first angle 114d and less than the third angle 118d. In an exemplary embodiment, the width of the window cut 110 may vary from the bottom surface 102d of the downlight cone 100 to the top surface 102c of the downlight cone 100 in a variety of different configurations than those illustrated in FIGS. 1aa, 1ab, 1ba, and 1bb.

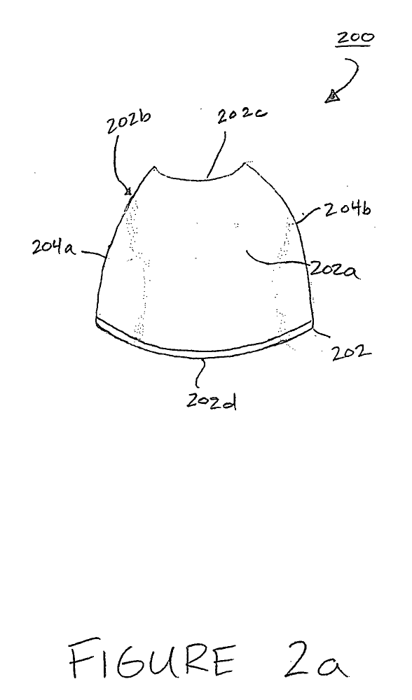

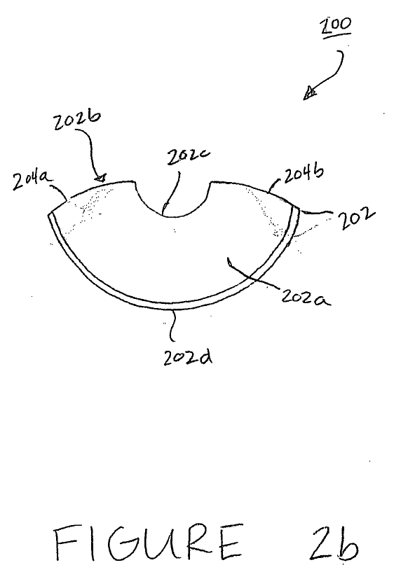

Referring now to FIGS. 2a and 2b, a kicker reflector 200 is illustrated. The kicker reflector 200 includes a base 202 having an outer surface 202a, an inner reflective surface 202b located opposite the outer surface 202a, a top surface 202c, and a bottom surface 202d located opposite the top surface 202c. The kicker reflector 200 may have a semi circular shape which is defined by a pair of side edges 204a and 204b which extend between the top surface 202c and the bottom surface 202d on opposite sides of the kicker reflector 200. In an exemplary embodiment, the kicker reflector has a semi circular shape which subtends an angle from 1 to 359 degrees. In an exemplary embodiment, the kicker reflector 200 may be, for example, a conventional kicker reflector known in the art.

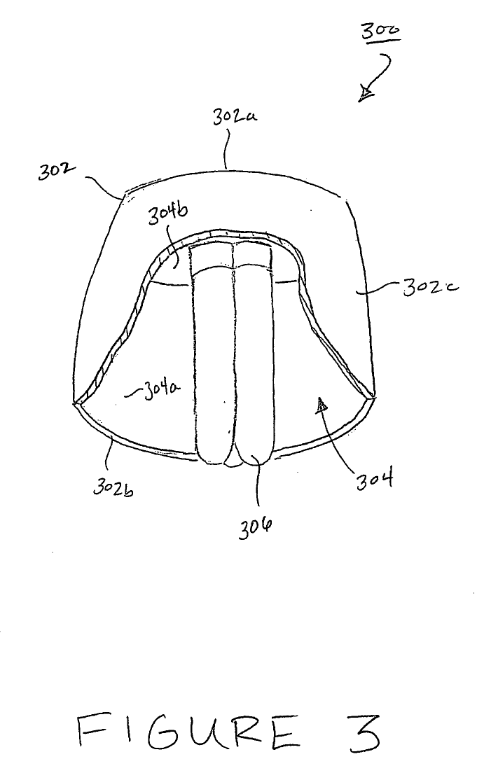

Referring now to FIG. 3, a lighting device 300 is illustrated. The lighting device 300 includes a base 302 having a top surface 302a, a bottom edge 302b located opposite the top surface 302a, and a side surface 302c extending between the top surface 302a and the bottom edge 302b and along the length of the lighting device 300. A light housing 304 is defined in the base 302 by an inner surface 304a which is located opposite the side surface 302c, and a light mounting surface 304b which is located opposite the top surface 302a and adjacent the inner surface 304a. A light source 306 extends from the light mounting surface 304b and out past the bottom edge 302b of the lighting device 300. In an exemplary embodiment, the light source 306 may be, for example, a fluorescent light, a compact fluorescent light, an incandescent light, a metal halide light, or a variety of other equivalent lights known in the art.

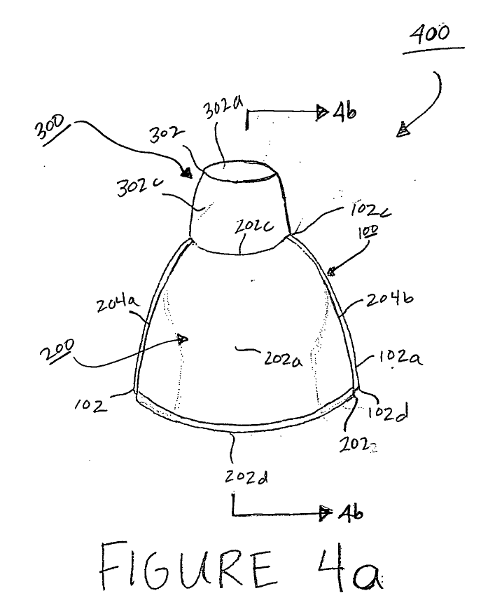

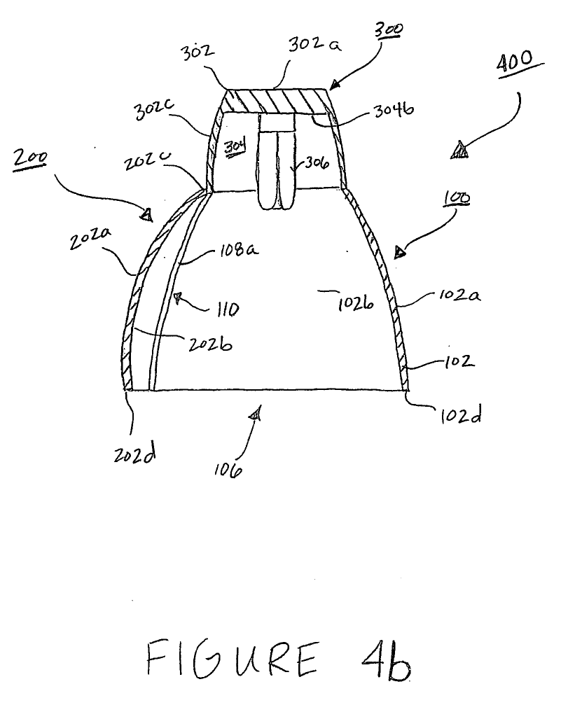

Referring now to FIGS. 1aa, 1ab, 1ba, 1bb, 2a, 2b, 3, 4a, and 4b, a lighting apparatus 400 is illustrated. The lighting apparatus 400 includes the lighting device 300 mounted to the downlight cone 100 by coupling the bottom edge 302b of the lighting device 300 to the top surface 102c of the downlight cone 100 such that the light source 306 extends through the semicircular lighting device channel 104, as illustrated in FIG. 4b. In an exemplary embodiment, the lighting device 300 may be easily removeable from the downlight cone 100 in order to allow replacement or substitution of different lighting devices in the downlight cone 100. In an exemplary embodiment, the lighting device 300 and the downlight cone 100 may be fabricated together such that the lighting device 300 is not removeable from the downlight cone 100.

The lighting apparatus 400 also includes the kicker reflector 200 coupled to the downlight cone 100. The kicker reflector 200 is positioned adjacent the downlight cone 100 such that the inner reflective surface 202b is adajcent the window cut 110 on the downlight cone 100. The kicker reflector 200 is then coupled to the downlight cone 100 using methods known in the art, such that the side edges 204a and 204b are adjacent the symmetrical contours 108a and 108b, respectively, and the window cut 110 is covered by the inner reflective surface 202b on the kicker reflector 200, as illustrated in FIGS. 4a and 4b. With the kicker reflector 200 coupled to the downlight cone 100, the window cut 110 allows light from the light source 306 to reach portions of the inner reflective surface 202b.

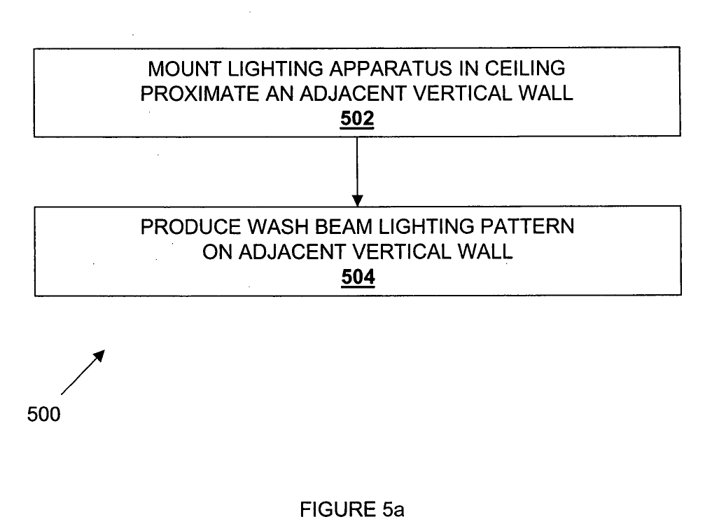

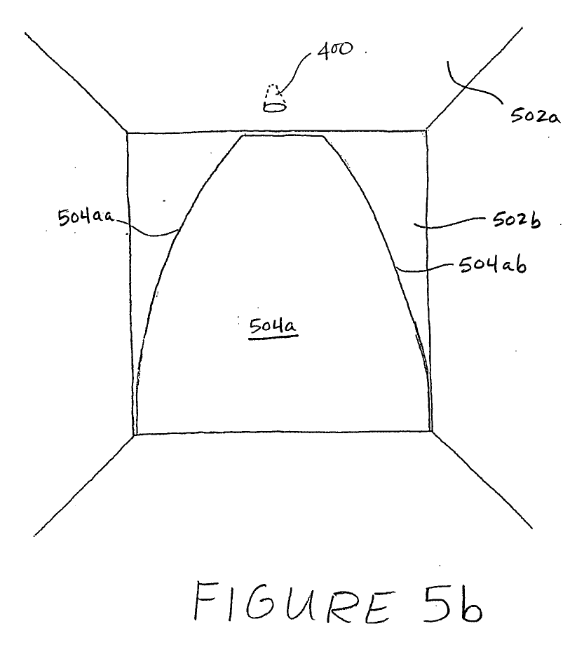

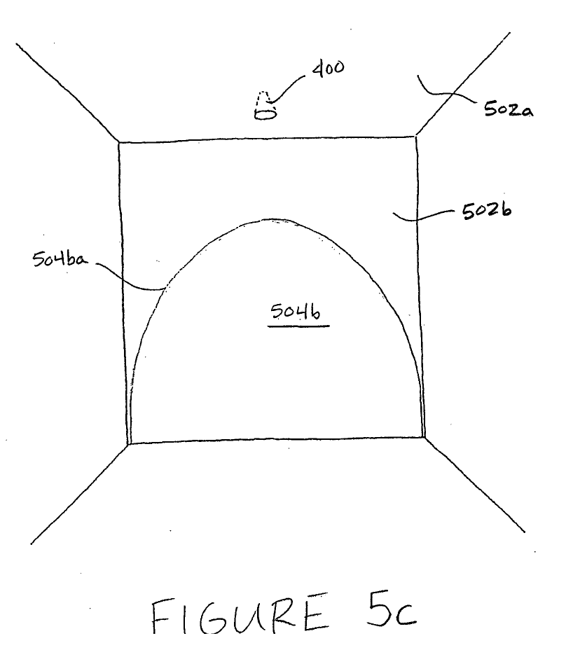

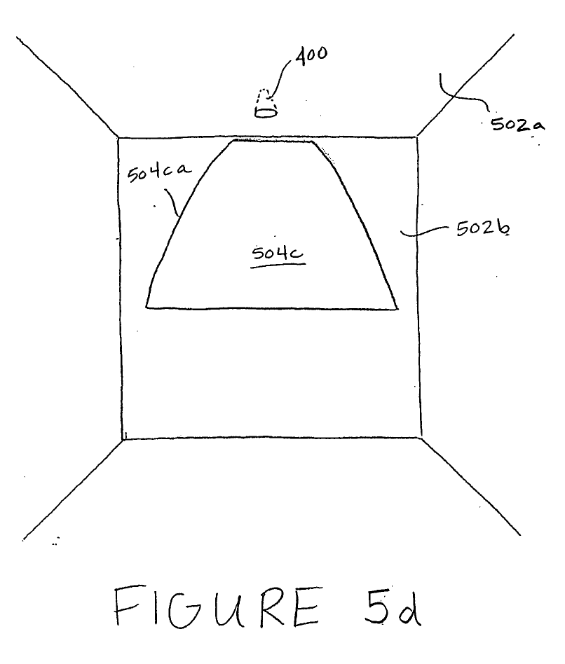

Referring now to FIGS. 5a, 5b, 5c, and 5d, a method 500 for providing light begins at step 502 where the lighting apparatus 400 is mounted in a ceiling 502a proximate an adjacent vertical wall 502b. The method 500 then proceeds to step 504 in which the lighting apparatus 400 is turned on in a conventional manner thereby producing a wash beam lighting pattern 504a on the adjacent vertical wall 502b.

In an exemplary embodiment, as illustrated in FIG. 5b, the wash beam pattern 504a produced on the adjacent vertical wall 502b includes a pair of outer boundary edges 504aa and 504ab which are continuous and free of inflection points.

In an exemplary embodiment, the wash beam lighting pattern 504a produced in step 504 is the result of a combination of a scallop beam pattern 504b and a trapezoidal beam pattern 504c, both produced by the lighting apparatus 400.

In an exemplary embodiment, as illustrated in FIG. 5c, the scallop beam pattern 504b is produced by a combination of the light source 306 itself and the downlight cone 100 of the lighting apparatus 400 reflecting a portion of the light from the light source 306 to produce the scallop beam pattern 504b on the adjacent vertical wall 502b having a substantially parabolic outer boundary edge 504ba.

In an exemplary embodiment, as illustrated in FIG. 5d, the trapezoidal beam pattern 504c is produced by the kicker reflector 200 of the lighting apparatus 400 reflecting a portion of the light from the light source 300 to produce the trapezoidal beam pattern 504c on the adjacent vertical wall 502b having a substantially trapezoidal outer boundary edge 504ca. In an exemplary embodiment, at least a portion of the shape of the trapezoidal beam pattern 504c is determined by the dimensions of the window cut 110 on the downlight cone 100.

In an exemplary embodiment, the symmetrical contours 108a and 108b which define the width of the window cut 110 on the downlight cone 100 may be modified in order to modify how the light is reflected by the kicker reflector 200 of the lighting apparatus 400 in order to adjust the precise shape of the trapezoidal beam pattern 504c depending on the beam pattern coverage that is desired on the adjacent vertical wall 502b.

In an exemplary embodiment, the wash beam pattern 504a is a combination of the scallop beam pattern 504b and the trapezoidal beam pattern 504c and provides the visual appearance of one single beam entity rather than a patchwork of dissonant beam shapes, and does not allow a viewer to distinguish the contribution of the kicker reflector 200 to the wash beam pattern 504a. In an exemplary embodiment, the symmetrical contours 108a and 108b, which define the width of the window cut 110 on the downlight cone 100, may be modified in order to modify how the light is reflected by the kicker reflector 200 in order to adjust the shape of the trapezoidal beam pattern 504c to ensure a wash beam pattern 504a which is continuous and free of inflection points for a variety of different embodiments of the scallop beam pattern 504b.

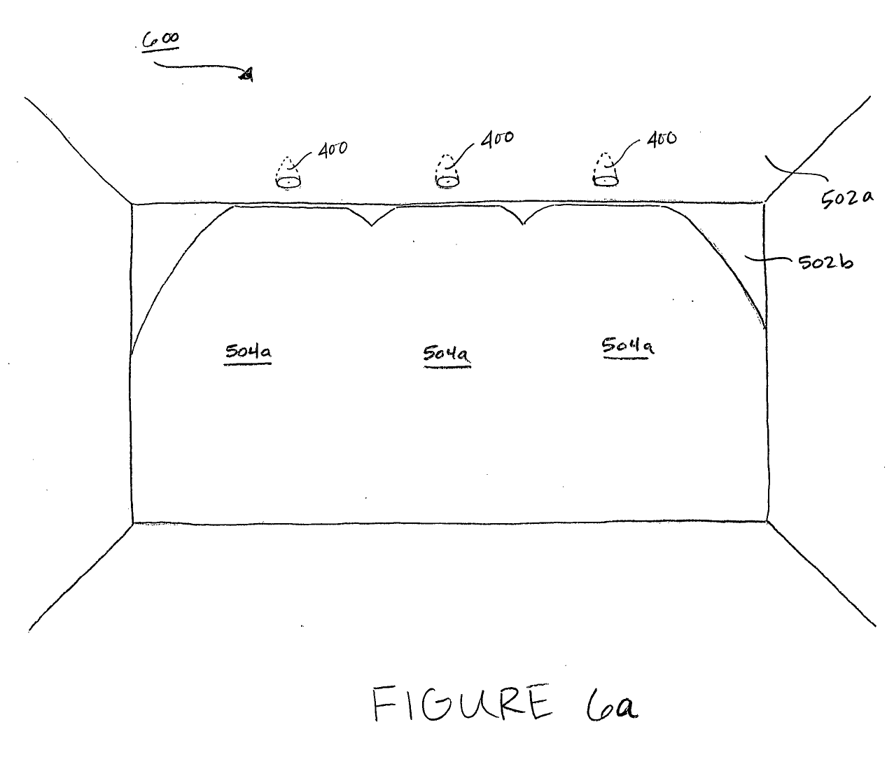

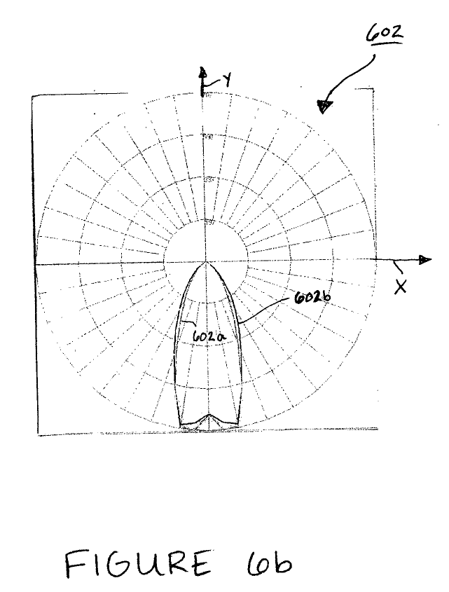

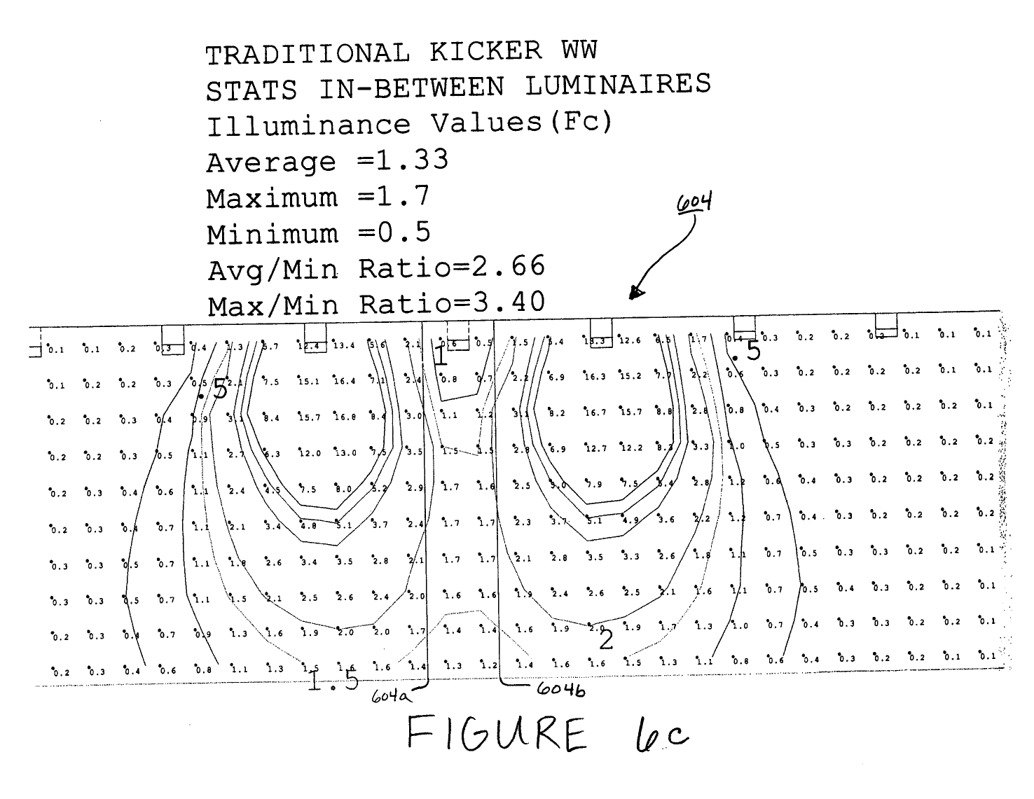

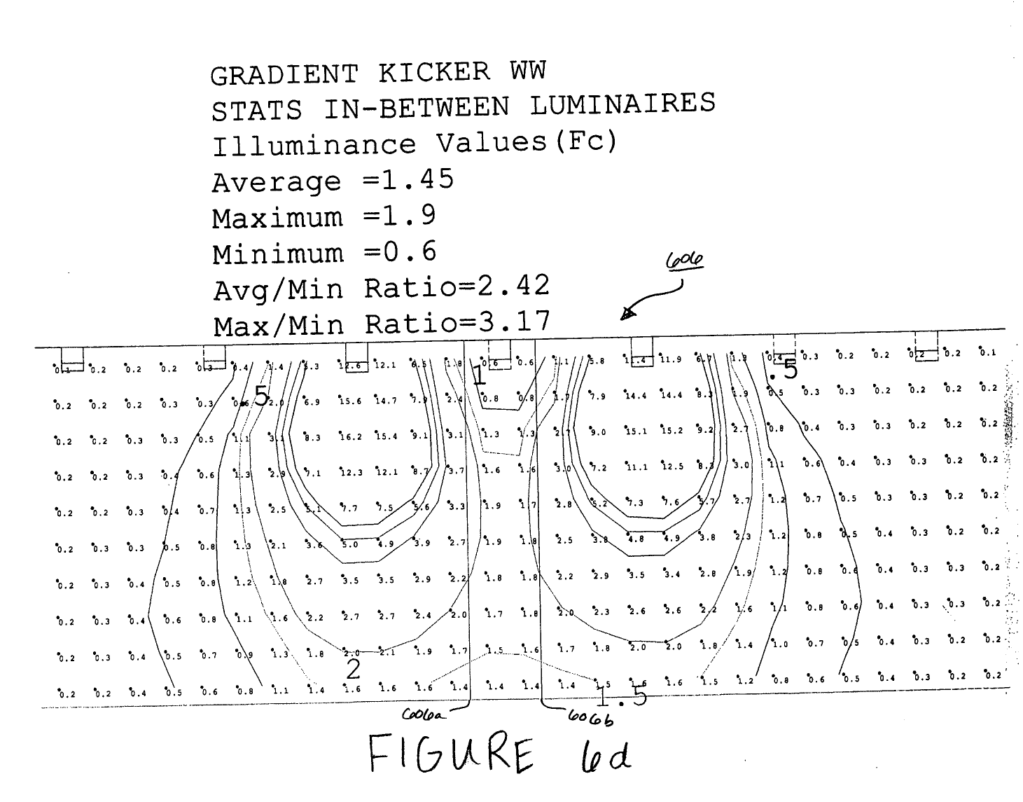

In an exemplary embodiment, as illustrated in FIG. 6a, a plurality of the lighting apparatus 400 may be mounted within the ceiling 502a and placed in spaced apart orientations adjacent the vertical wall 502b in order to provide a lighting system 600 for providing light on the adjacent vertical wall 502b. Because of the coverage area and shape of the wash beam pattern 504a provided by each of the lighting apparatus 400, the lighting apparatus of the lighting system 600 may be spaced further apart than conventional lighting apparatus while still providing a uniform lighting of the vertical wall 502b.

Referring now to FIGS. 6a, 6b, 6c, and 6d, in an experimental embodiment, the illuminance provided by the lighting system 600 of FIG. 6a was compared to the illuminance of a conventional lighting system. The conventional lighting system included a plurality of conventional lighting apparatus having 26 W triple tube CFL lamps, specular anodized aluminum reflectors, and conventional 130 degree constant angle window cuts, with each conventional lighting apparatus spaced 8 feet from each other, 1 foot from the wall 502b, and in a 10 foot high ceiling 502a. The lighting system 400 included a plurality of the lighting apparatus 400 having 26 W triple tube CFL lamps, specular anodized aluminum reflectors, and the window cut 110, described above with reference to FIGS. 1aa, 1ab, 1ba, and 1bb, with each lighting apparatus 400 spaced 8 feet from each other, 1 foot from the wall 502b, and in a 10 foot high ceiling 502a.

A polar plot 602 at 90 degrees, or parallel to the wall 502b, includes plots for one of the lighting apparatus 400 in lighting system 600 and one of the conventional lighting apparatus in the conventional lighting system, the plots superimposed on each other, illustrated in FIG. 6b. The conventional lighting apparatus produces a plot 602a, and the lighting apparatus 400 produces a plot 602b. The plots 602a and 602b shows that the lighting apparatus 400 produces greater luminous intensities nearer the lighting apparatus 400 than the conventional lighting apparatus, providing greater luminous intensities on the portions of the wall 502b near the ceiling 502a.

A polar plot 604 at 90 degrees, or parallel to the wall 502b, includes a plot for the conventional lighting system including two conventional lighting apparatus, illustrated in FIG. 6c. Two vertical lines 604a and 604b define an area of illuminance between the two conventional lighting apparatus. A polar plot 606 at 90 degrees, or parallel to the wall 502b, includes a plot for the lighting system 600 including two conventional lighting apparatus 400, illustrated in FIG. 6d. Two vertical lines 606a and 606b define an area of illuminance between the two conventional lighting apparatus. The plot 604 shows that, for the conventional lighting system, the area of illuminance defined by the vertical lines 604a and 604b includes an average illuminance of 1.33 Fc, a maximum illuminance of 1.7 Fc, a minimum illuminance of 0.5 Fc, an average illuminance to minimum illuminance ratio of 2.66, and a maximum illuminance to minimum illuminance ratio of 3.4. The plot 606 shows that, for the lighting system 600, the area of illuminance defined by the vertical lines 606a and 606b includes an average illuminance of 1.45 Fc, a maximum illuminance of 1.9 Fc, a minimum illuminance of 0.6 Fc, an average illuminance to minimum illuminance ratio of 2.42, and a maximum illuminance to minimum illuminance ratio of 3.17. Thus, the lighting system 600 provides an illuminance between lighting apparatus 400 which has a higher average illuminance, a higher maximum illuminance, and a higher minimum illuminance than a conventional lighting system with conventional lighting apparatus having the same positioning. Furthermore, the lighting system 600 provides more uniform light between the lighting apparatus 400, as shown by the lower average illuminance to minimum illuminance ratio and the lower maximum illuminance to minimum illuminance ratio relative to the conventional lighting system with conventional lighting apparatus having the same positioning.

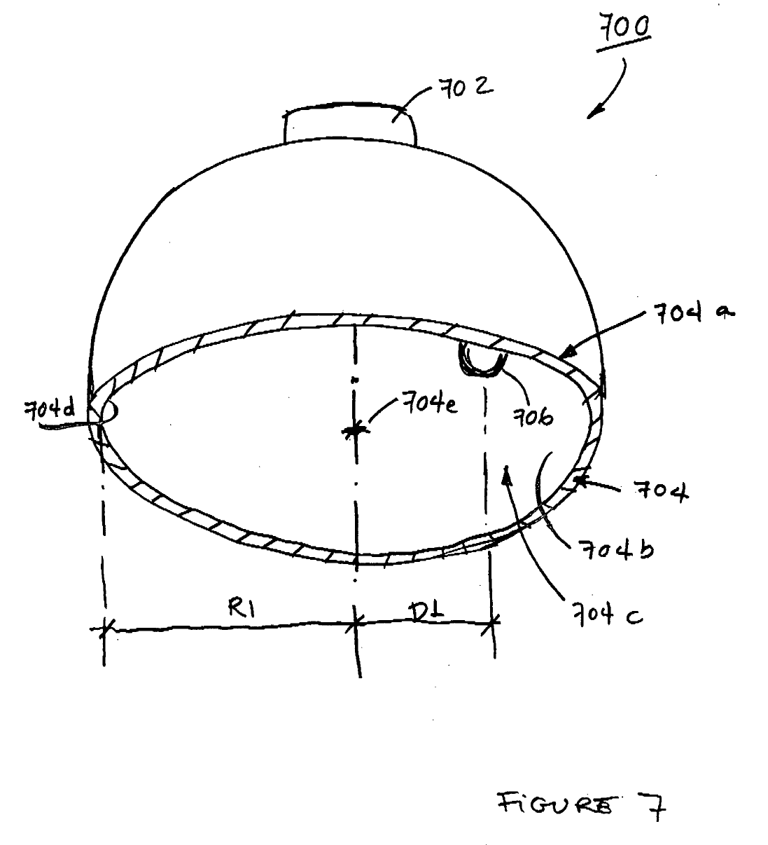

Referring now to FIG. 7, a lighting apparatus 700 is illustrated. The lighting apparatus 700 includes a support base 702 which may be connected to a conventional power source known in the art. A concave spherical mirror 704 is coupled to the support base 702 on an outer surface 704a. An inner reflective surface 704b on the concave spherical mirror 704 is located opposite the outer surface 704a and defines a light source housing 704c having an entrance 704d. The concave spherical mirror 704 also includes a radius of curvature R₁ measured from a center 704e of the concave spherical mirror 704 to the inner reflective surface 704b. A light source 706 is positioned in the light source housing 704c and coupled to the concave spherical mirror 704 at a distance D₁ from the center 704e of the concave spherical mirror 704, which is approximately equal to R₁/2.

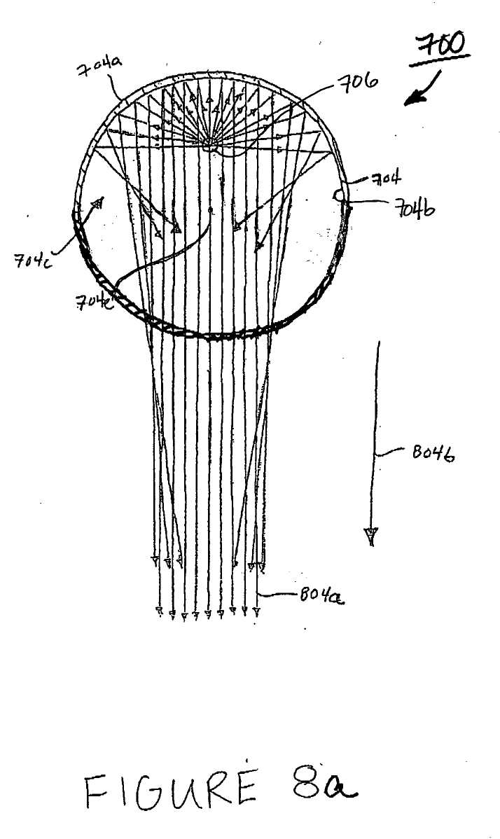

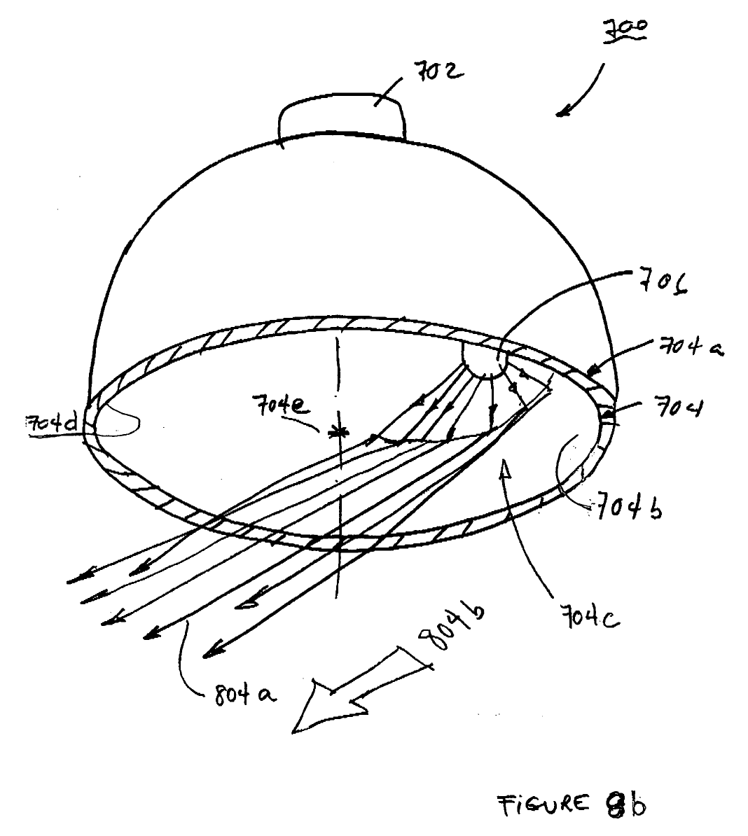

Referring now to FIGS. 8a and 8b, the light source 706 of the light apparatus 700 may be turned on in a conventional manner such as, for example, supplying power to the light source 706 using methods known in the art. With power supplied to the light source 706 of the light apparatus 700, a plurality of light rays 804a are emitted from the light source 706. Because the positioning of the light source 706 in the concave spherical mirror 704 at the distance D₁ from the center 704e of the concave spherical mirror 704 which is approximately equal to R₁/2, many of the light rays 804a will be reflected parallel to each other and in a direction 804b and out of the entrance 704d of the light source housing 704c, as illustrated in FIGS. 8a and 8b. With the positioning of the light source 706 in the concave spherical mirror 704 at the distance D₁, the light rays 804a provide a substantially parabolic light pattern.

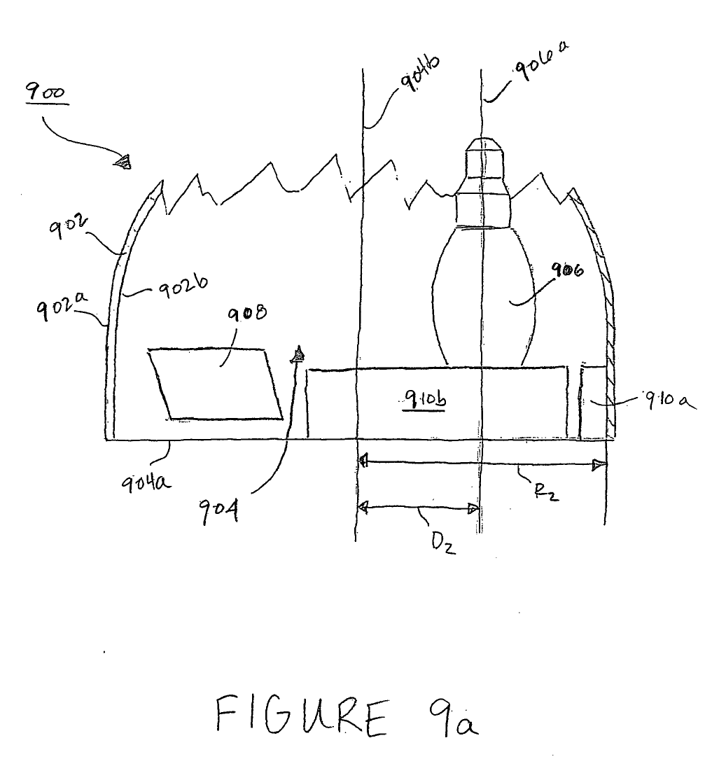

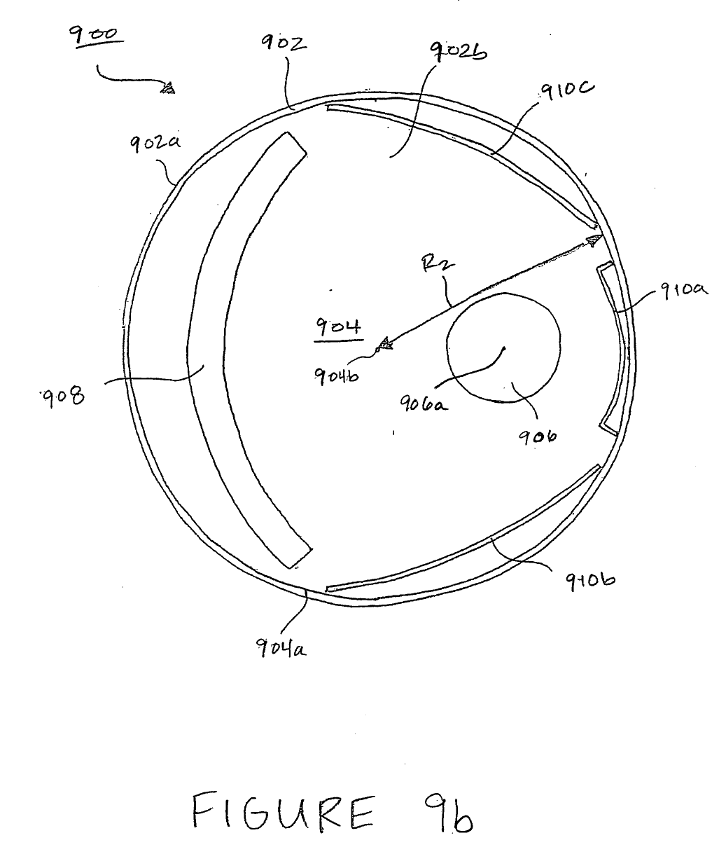

Referring now to FIGS. 9a and 9b, a lighting apparatus 900 is illustrated. The lighting apparatus 900 includes a base 902 having an outer surface 902a. An inner reflective surface 902b is located opposite the outer surface 902a and defines a light source housing 904 having a circular entrance 904a. In an exemplary embodiment, the inner reflective surface 902b is a concave spherical mirror such as, for example, the concave spherical mirror 704 described above with reference to FIGS. 7, 8a, and 8b. In an exemplary embodiment, in addition to or in place of a smooth continuous surface, the inner reflective surface 902b may be fabricated from, for example, a polar array of flutes or flats in a circular orientation about the axis 904b of the base 902. The light source housing 904 includes a longitudinal axis 904b which is substantially centrally located on the base 902 and through the center of the circular entrance 904a a distance R₂ from the inner reflective surface 902b adjacent the circular entrance 904a. In an exemplary embodiment, the distance R₂ is the radius of the circular entrance 904a. A light source 906 is coupled to the base 902 and positioned in an off-set relationship in the light source housing 904 such that a longitudinal axis 906a of the light source 906 is a distance D₂ from the longitudinal axis 904b of the light source housing 904. In an exemplary embodiment, the distance D₂ is approximately equal to the distance R₂/2. An arcuate house side reflector 908 is coupled to the inner reflective surface 902b adjacent the circular entrance 904a and on an opposite side of the longitudinal axis 904b in the light source housing 904 as the light source 906. A faceted insert 910a is coupled to the inner reflective surface 902b adjacent the circular entrance 904a and the light source 906, and a pair of faceted inserts 910b and 910c are coupled to the inner reflective surface 902b adjacent the circular entrance 904a and on opposite sides of the light source 906 and the faceted insert 910a.

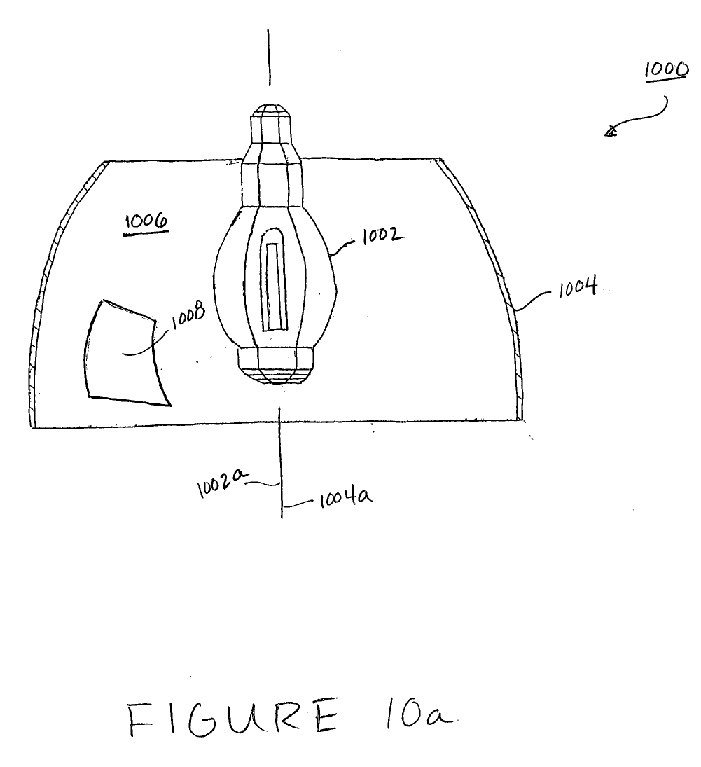

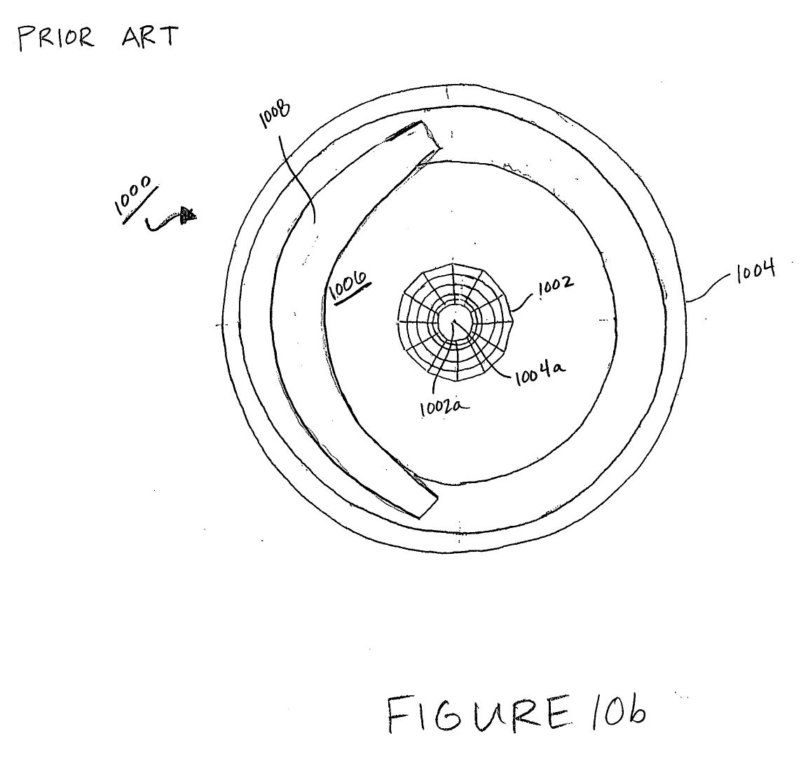

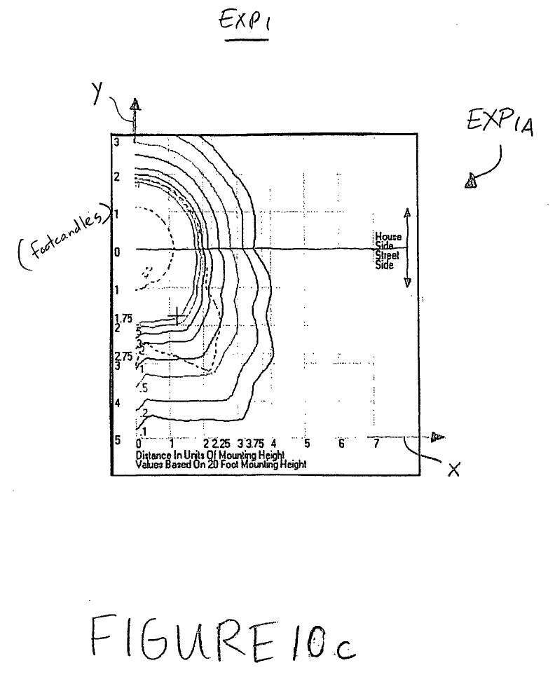

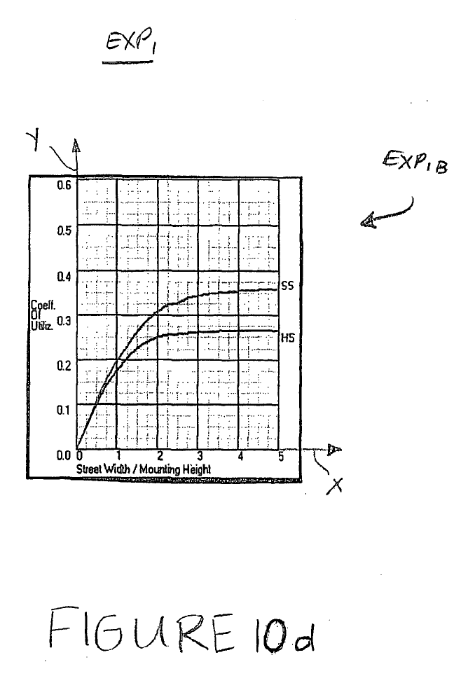

Referring now to FIGS. 10a and 10b, a conventional light providing apparatus 1000 is illustrated. The conventional light providing apparatus 1000 includes a conventional light source 1002 having a light source axis 1002a which is coupled to a conventional concave reflector 1004 having a reflector axis 1004a through a conventional light source coupling device, which has been omitted for clarity, such that the light source axis 1002a on the light source 1002 is aligned with the reflector axis 1004a on the concave reflector 1004 and the light source 1002 is centrally located in a light source housing 1006 which is defined by the concave reflector 1004, as illustrated in FIGS. 10a and 10b. A conventional insert 1008 is positioned in the light source housing 1006 adjacent the light source 1002 in order to provide an asymmetrical light distribution from the light source 1002.

Referring now to FIGS. 10c and 10d, in an experimental embodiment EXP₁, the conventional asymmetrical lighting apparatus 1000 was tested. The graph EXP_{1A} is a iso-footcandle plot for the conventional asymmetrical lighting apparatus 1000 mounted at a 20 foot height, with the distance from the light mounting location on the Y-axis and the distance in units of mounting height on the X-axis. The Y-axis is divided into distances away from the light on the house side and on the street side. The graph EXP_{1A} shows that an asymmetrical light distribution towards the street side of the conventional asymmetrical lighting apparatus 1000 mounting location. The graph EXP_{1B} shows what percentage of light is directed towards the house side and the street side by plotting the coefficient of utilization versus the street width divided by the mounting height. The conventional asymmetrical lighting apparatus 1000 was found to have a coefficient of utilization of approximately 0.35 or 35% on the street side and 0.26 or 26% on the house side, resulting in a total efficiency of 61%.

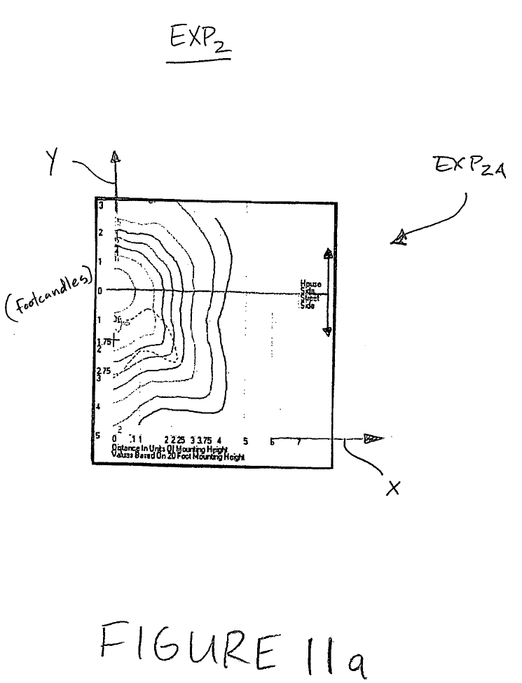

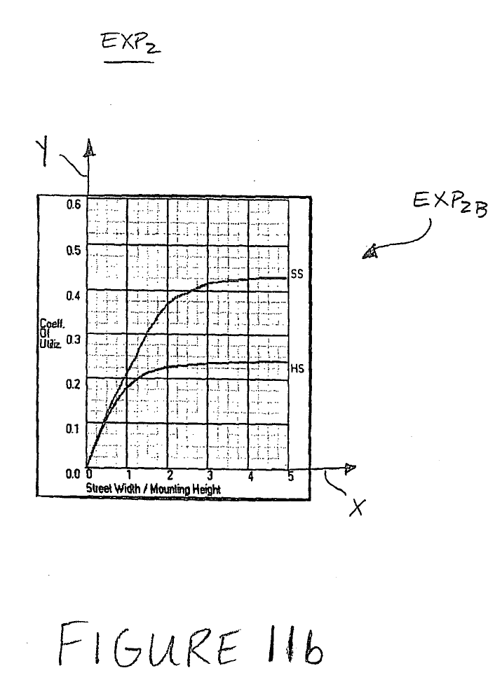

Referring now to FIGS. 11a and 11b, in an experimental embodiment EXP₂, the lighting apparatus 900, described above with reference to FIGS. 9a and 9b, was tested. The graph EXP_{2A} is a iso-footcandle plot for the light mounted at a 20 foot height, with the distance from the light mounting location on the Y-axis and the distance in units of mounting height on the X-axis. The Y-axis is divided into distances away from the light on the house side and on the street side. The graph EXP_{2A} shows that the asymmetrical light distribution towards the street side of the lights mounting location produced by the lighting apparatus 900 reaches greater distances from the light on the street side than the conventional asymmetrical lighting apparatus 1000. This was an unexpected result. The graph EXP_{2B} shows what percentage of light is directed towards the house side and the street side by plotting the coefficient of utilization versus the street width divided by the mounting height. The lighting apparatus 900 was found to have a coefficient of utilization of approximately 0.43 or 43% on the street side and 0.24 or 24% on the house side, an increase in the coefficient of utilization on the street side and a decrease in the coefficient of utilization on the house side as compared to the conventional asymmetrical lighting apparatus 1000 with an increase of total efficiency to 67%. This was an unexpected result.

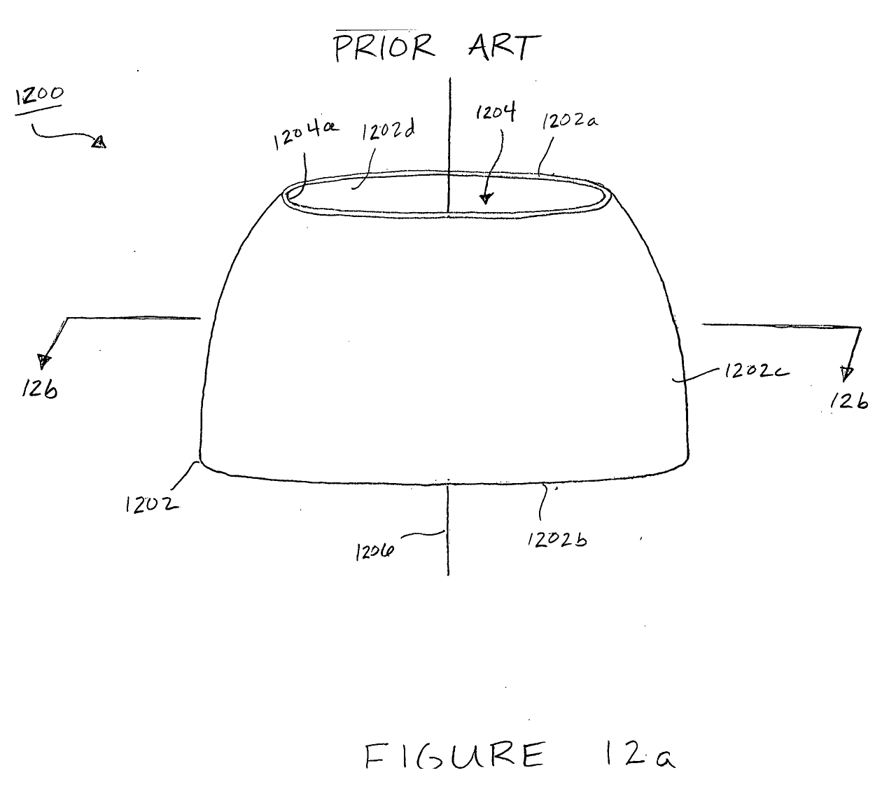

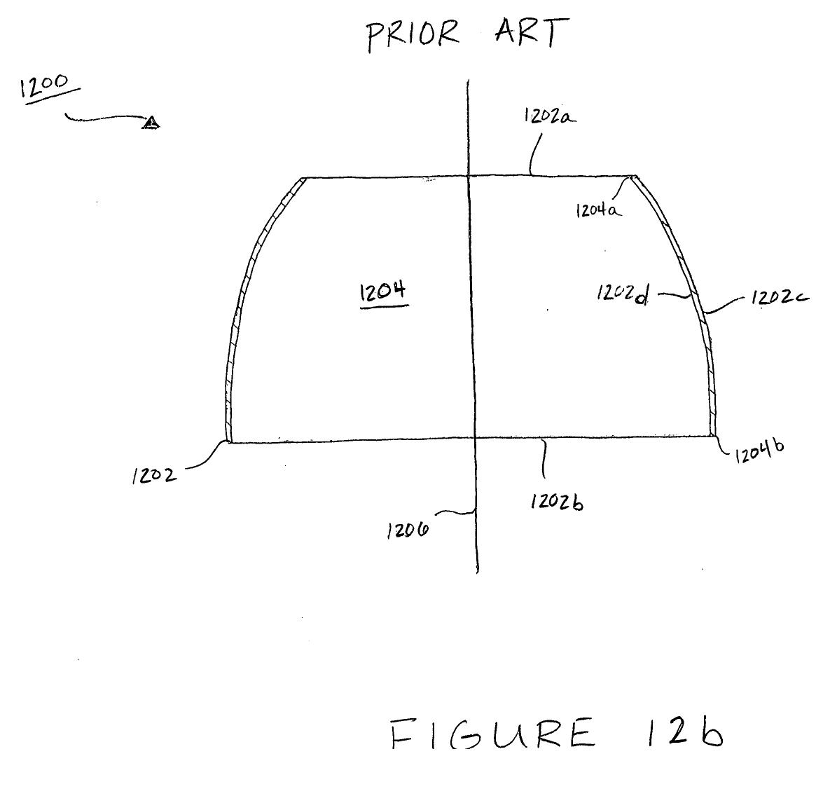

Referring now to FIGS. 12a and 12b, a conventional concave reflector 1200 is illustrated. The concave reflector 1200 includes a tubular base 1202 having a top edge 1202a, a bottom edge 1202b located opposite the top edge 1202a, an outer surface 1202c extending between the top edge 1202a and the bottom edge 1202b, and an inner surface 1202d located opposite the outer surface 1202c and extending between the top edge 1202a and the bottom edge 1202b. A light source housing 1204 is defined by the base 1202 and located adjacent the inner surface 1202d. The light source housing 1204 includes a circular top opening 1204a located adjacent the top edge 1202a, and a circular bottom opening 1204b located adjacent the bottom edge 1202b. A reflector axis 1206 is centrally located in the light source housing 1204 and runs through the axis off the circular top opening 1204a and the circular bottom opening 1204b. In an exemplary embodiment, the base 1202 has a substantially circular cross section in planes which are perpendicular to the reflector axis 1206. In an exemplary embodiment, the concave reflector 1200 is a conventional concave reflector known in the art. In an exemplary embodiment, the inner surface 1202d of the base 1202 includes a conventional reflecting material known in the art. In an embodiment, the concave reflector 1200 includes a light source coupling device, which has been omitted for clarity, located adjacent the top edge 1202a of the base 1202.

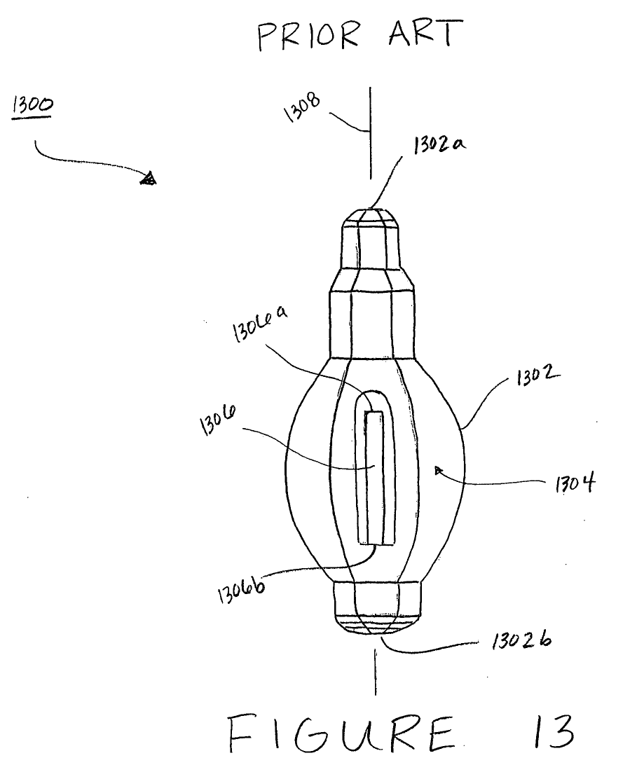

Referring now to FIG. 13, a conventional light source 1300 is illustrated. The light source 1300 includes a translucent base 1302 having a top end 1302a and a bottom end 1302b located opposite the top end 1302a. The base 1302 defines an arc tube cavity 1304 with an arc tube 1306 is coupled to the base 1302 and centrally located in the arc tube cavity 1304. The arc tube 1306 includes an arc tube top 1306a and an arc tube bottom 1306b located opposite the arc tube top 1306a. A light source axis 1308 is centrally located on the base 1302 and runs through the center of the arc tube cavity 1304 and the arc tube 1306. In an embodiment, the light source 1300 is a conventional light source known in the art.

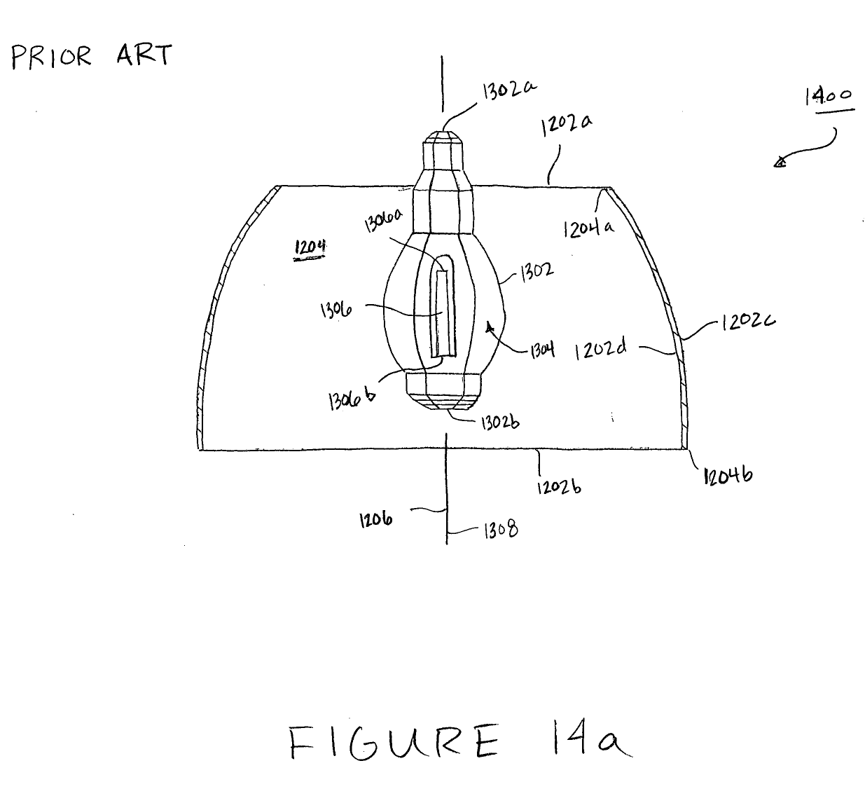

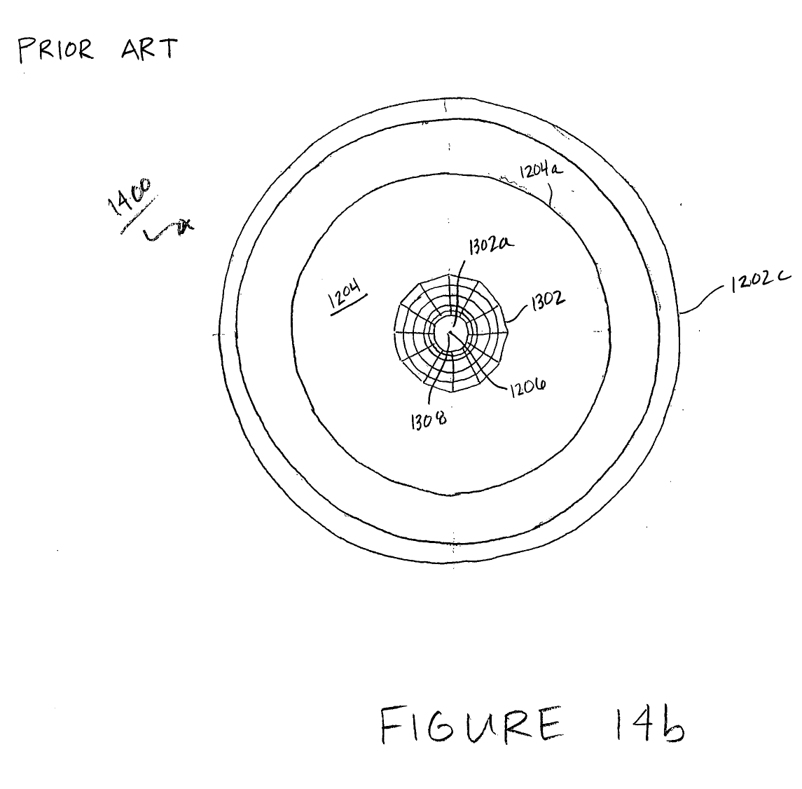

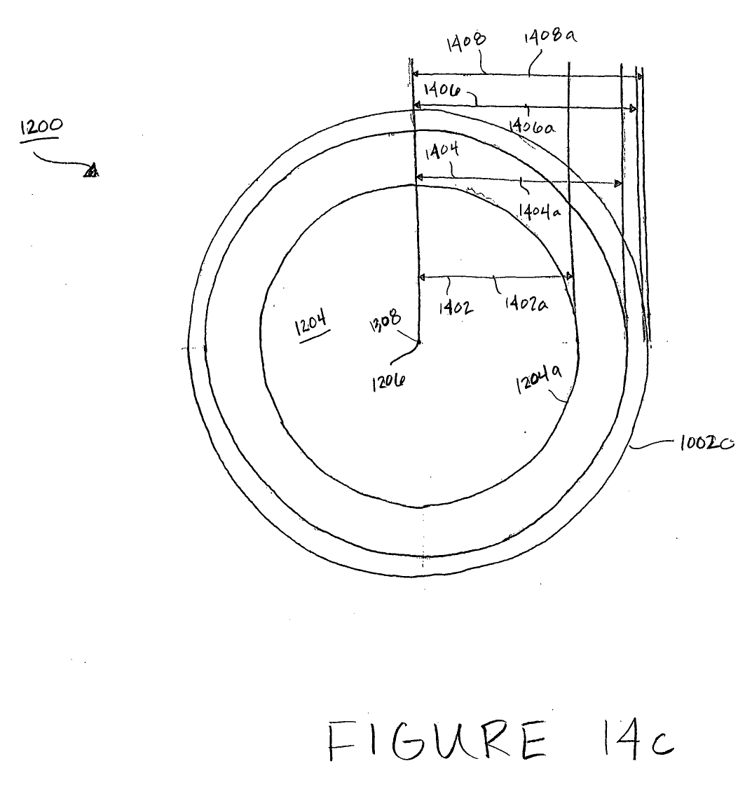

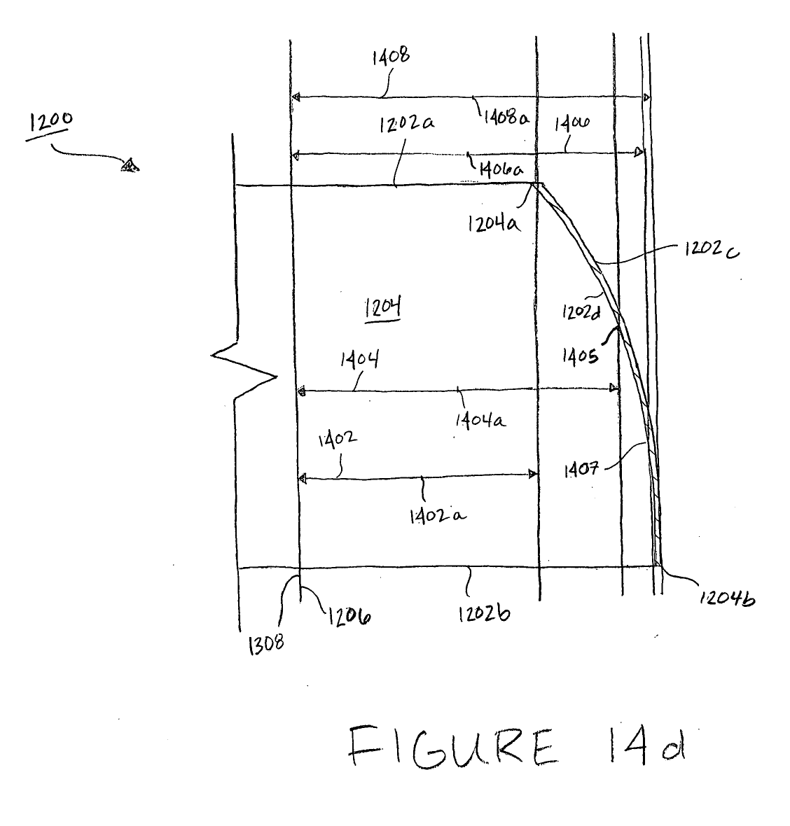

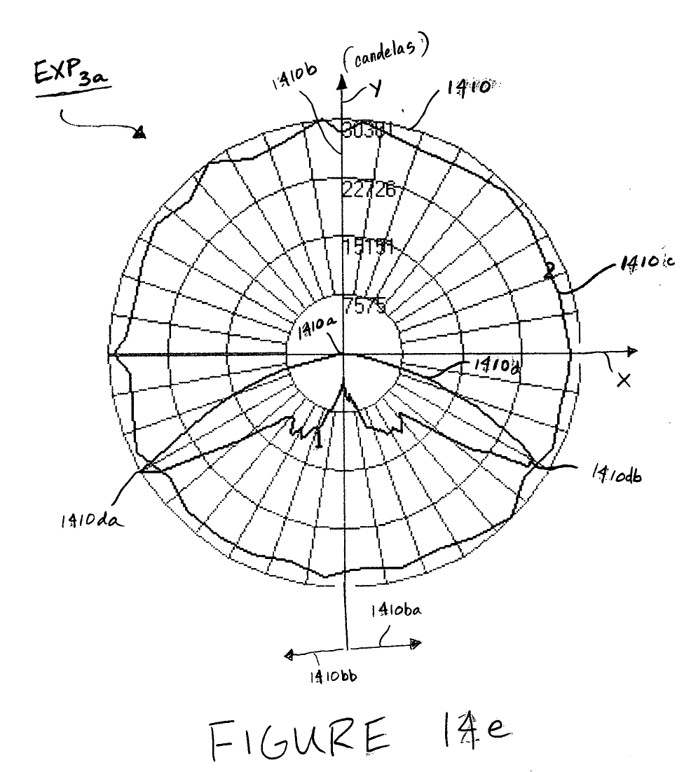

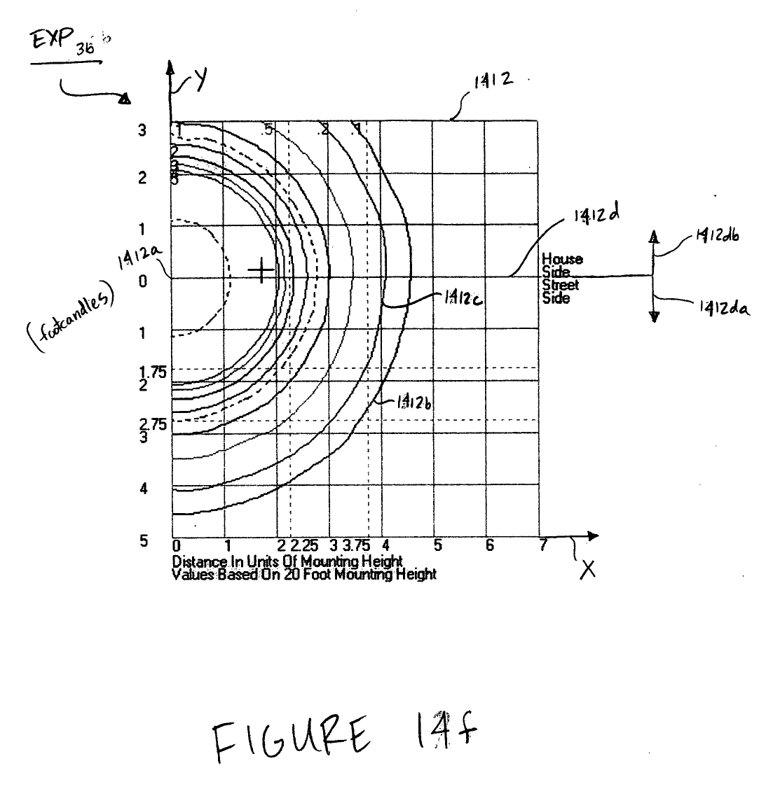

Referring now to FIGS. 12a, 12b, 13, 14a and 14b, a conventional light providing apparatus 1400 is illustrated. The conventional light providing apparatus 1400 includes the light source 1300 coupled to the concave reflector 1200 through a light source coupling device, which has been omitted for clarity, such that the light source axis 1308 on the light source 1300 is aligned with the reflector axis 1206 on the concave reflector 1200 and the light source 1300 is centrally located in the light source housing 1204, as illustrated in FIGS. 14a and 14b.

Referring now to FIGS. 14a, 14b, 14c, and 14d, the methodology of the present disclosure references a number of distances and positions which may be defined in the concave reflector 1200 with reference to the conventional light providing apparatus 1400 in order to analyze the design of the light providing apparatus 1400. Furthermore, analogous distances may be used to analyze the design of reflectors generally. A distance 1402 is defined as the distance between reflector axis 1206 and the top opening 1204a on the concave reflector 1200. A half top opening position 1402a is defined as a position located half the distance 1402 between the reflector axis 1206 and the top opening 1204a. A plane which is perpendicular to the reflector axis 1206 and intersects the arc tube top 1306a of the light source 1300 will intersect the inner surface 1202d of the concave reflector 1200 at a distance 1404 from the reflector axis 1206 at an arc tube top point 1405. A half arc tube top position 1404a is defined as a position located half the distance 1404 between the reflector axis 1206 and the arc tube top point 1405. A plane which is perpendicular to the reflector axis 1206 and intersects the arc tube bottom 1306b of the light source 1300 will intersect the inner surface 1202d of the concave reflector 1200 at a distance 1406 from the reflector axis 1206 at an arc tube bottom point 1407. A half arc tube bottom position 1406a is defined as a position located half the distance 1406 between the reflector axis 1206 and the arc tube bottom point 1407. A distance 1408 is defined as the distance between reflector axis 1206 and the bottom opening 1204b on the concave reflector 1200. A half bottom opening position 1408a is defined as a position located half the distance 1408 between the reflector axis 1206 and the top opening 1204a.

Referring now to FIG. 14e, in an experimental embodiment EXP₃ₐ, a candela plot 1410 is illustrated. The candela plot 1410 of experimental embodiment EXP₃ₐ shows the light distribution for the conventional light providing apparatus 1400, described above with reference to FIGS. 14a and 14b. In the candela plot 1410 of experimental embodiment EXP₃ₐ, the conventional light providing apparatus 1400 is centered at point 1410a, and different luminous intensities of the light provided by the conventional light providing apparatus 1400 are recorded in different planes. A vertical line 1410b on the candela plot 1410 of experimental embodiment EXP₃ₐ separates a street side 1410ba of the conventional light providing apparatus 1400 from a house side 1410bb of the conventional light providing apparatus 1400. A plot line 1410c is the luminous intensity of the light in a plane looking down on the conventional light providing apparatus 1400 from above. The plot line 1410c shows that the luminous intensity of the light provided by the conventional light providing apparatus 1400 is substantially symmetrical in the 360 degrees about the light source 1300 and on the street side 1410ba and the house side 1410bb of the conventional light providing apparatus 1400. A plot line 1410d is the luminous intensity of the light in a plane looking at the conventional light providing apparatus 1400 from the side of the conventional light providing apparatus 1400. The plot line 1410d shows that the luminous intensity of the light provided by the conventional light providing apparatus 1400 is symmetrical on the street side 1410ba and the house side 1410bb of the conventional light providing apparatus 1400, with a peak 1410da and a peak 1410db in the luminous intensity at approximately 60 degrees from either side of the vertical line 1410b on the candela plot 1410 of experimental embodiment EXP₃ₐ. Thus, the conventional light providing apparatus 1400 provides light with a symmetrical luminous intensity.

Referring now to FIG. 14f, in an experimental embodiment EXP_{3b}, an isofootcandle plot 1412 is illustrated. The isofootcandle plot 1412 of experimental embodiment EXP_{3b} shows the light pattern produced by the conventional light providing apparatus 1400, described above with reference to FIGS. 14a and 14b. In the isofootcandle plot 1412 of experimental embodiment EXP_{3b}, the conventional light providing apparatus 1400 is centered at point 1412a, and isofootcandle lines such as, for example, line 1412b and line 1412c, plot equal footcandle levels when the conventional light providing apparatus 1400 was mounted at a 20 foot mounting height. A horizontal line 1412d on the isofootcandle plot 1412 of experimental embodiment EXP_{3b} separates a street side 1412da of the conventional light providing apparatus 1400 from a house side 1412db of the conventional light providing apparatus 1400. The isofootcandle plot 1412 of experimental embodiment EXP_{3b} shows that the conventional light providing apparatus 1400 produces substantially circular and symmetrical isofootcandle lines which are centered at point 1412a. Thus, the conventional light providing apparatus 1400 provides light with symmetrical isofootcandle lines.

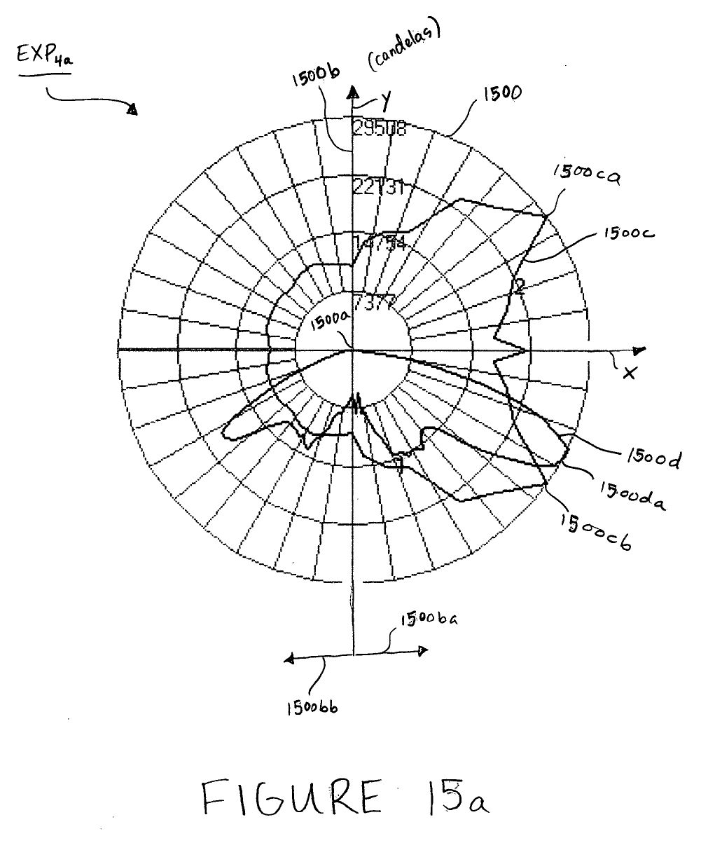

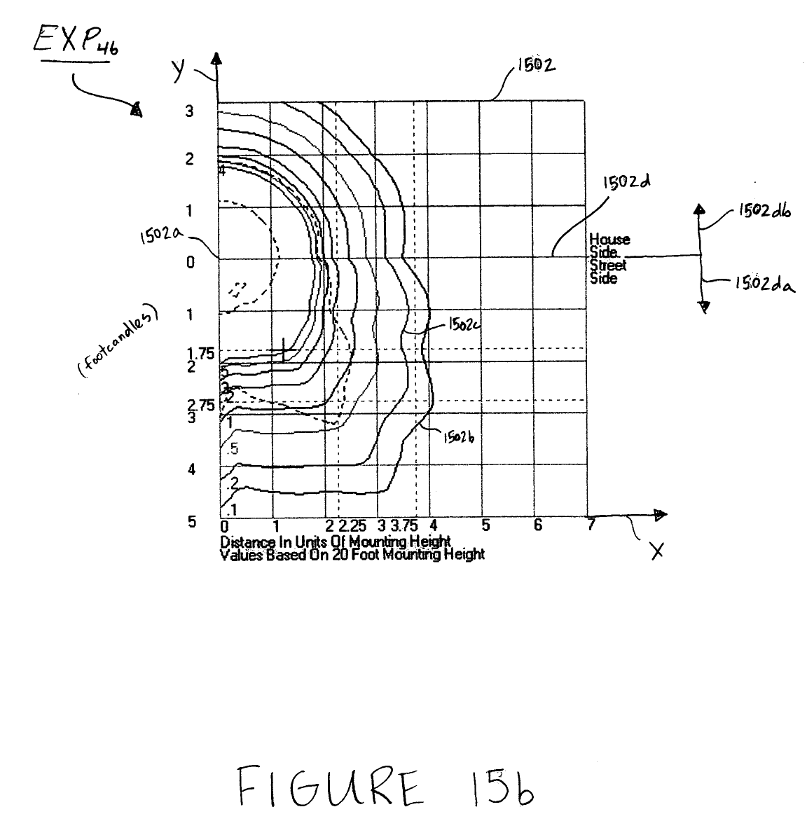

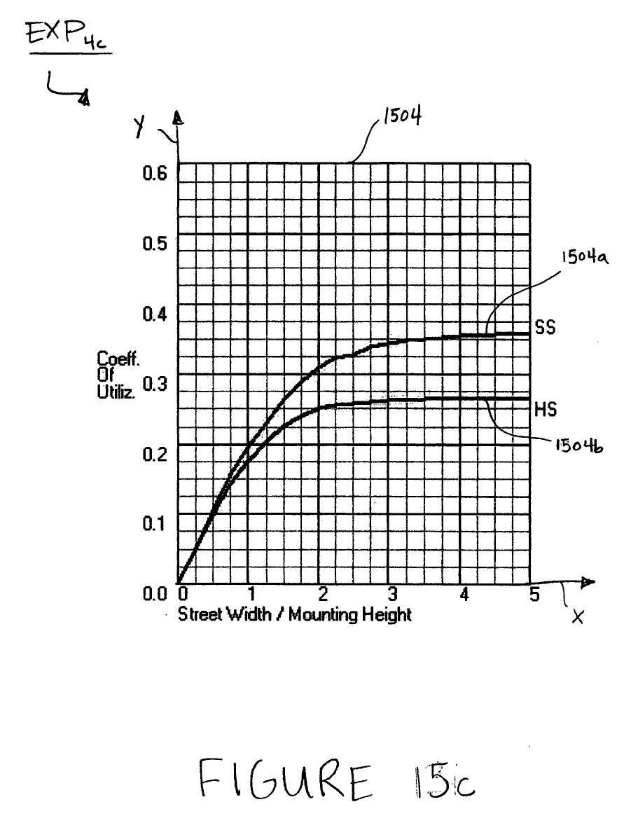

Referring now to FIGS. 14a, 14b, and 15a, if an asymmetric light pattern is desired from the conventional light providing apparatus 1400, a plurality of conventional inserts are typically positioned in the light source housing 1204 using methods known in the art in order to direct the light from the light source 1300. In an experimental embodiment EXP₄ₐ, a candela plot 1500 is illustrated. The candela plot 1500 of experimental embodiment EXP₄ₐ shows the light distribution for the conventional light providing apparatus 1400 with the plurality of conventional inserts used to provide an asymmetrical light pattern. In the candela plot 1500 of experimental embodiment EXP₄ₐ, the conventional light providing apparatus 1400 with the plurality of conventional inserts is centered at point 1500a, and different luminous intensities of the light provided by the conventional light providing apparatus 1400 with the plurality of conventional inserts are recorded in different planes. A vertical line 1500b on the candela plot 1500 of experimental embodiment EXP₄ₐ separates a street side 1500ba of the conventional light providing apparatus 1500 from a house side 1500bb of the conventional light providing apparatus 1500. A plot line 1500c is the luminous intensity of the light in a plane looking down on the conventional light providing apparatus 1400 with the plurality of conventional inserts from above. The plot line 1500c shows that the luminous intensity of the light provided by the conventional light providing apparatus 1400 with the plurality of conventional inserts provides an asymmetrical light distribution such that more light is provided on the street side 1500ba of the conventional light providing apparatus 1400 with the plurality of conventional inserts than is on the house side 1500bb of the conventional light providing apparatus 1400 with the plurality of conventional inserts, with a peak 1500ca and a peak 1500cb at approximately 35 degrees on either side of an X axis. A plot line 1500d is the luminous intensity of the light in a plane looking at the conventional light providing apparatus 1400 with the plurality of conventional inserts from the side of the conventional light providing apparatus 1400 with the plurality of conventional inserts. The plot line 1500d shows that the luminous intensity of the light provided by the conventional light providing apparatus 1400 with the plurality of conventional inserts provides an asymmetrical light distribution such that more light is provided on the street side 1500ba of the conventional light providing apparatus 1400 with the plurality of conventional inserts than is on the house side 1500bb of the conventional light providing apparatus 1400 with the plurality of conventional inserts, with a peak 1500da in the luminous intensity at approximately 65 degrees from the vertical line 1500b and on the street side 1500ba of the vertical line 1500b on the candela plot 1500 of experimental embodiment EXP₄ₐ.

Referring now to FIGS. 14a, 14b, and 15b, in an experimental embodiment EXP_{4b}, an isofootcandle plot 1502 is illustrated. The isofootcandle plot 1502 of experimental embodiment EXP_{4b} shows the light pattern produced by the conventional light providing apparatus 1400 with the plurality of conventional inserts. In the isofootcandle plot 1502 of experimental embodiment EXP_{4b}, the conventional light providing apparatus 1400 with the plurality of conventional inserts is centered at point 1502a, and isofootcandle lines such as, for example, line 1502b and line 1502c, plot equal footcandle levels when the conventional light providing apparatus 1400 with the plurality of conventional inserts was mounted at a 20 foot mounting height. A horizontal line 1502d on the isofootcandle plot 1502 of experimental embodiment EXP_{4b} separates a street side 1502da of the conventional light providing apparatus 1400 with the plurality of conventional inserts from a house side 1502db of the conventional light providing apparatus 1400 with the plurality of conventional inserts. The isofootcandle plot 1502 of experimental embodiment EXP_{4b} shows that the conventional light providing apparatus 1400 with the plurality of conventional inserts produces asymmetrical isofootcandle lines which are non-circular and skewed towards the street side 1502da of conventional light providing apparatus 1400 with the plurality of conventional inserts.

Referring now to FIGS. 14a, 14b, and 15c, in an experimental embodiment EXP_{4c}, an efficiency graph 1504 is illustrated. The efficiency graph 1504 of experimental embodiment EXP_{4c} plots the coefficient of utilization for the conventional light providing apparatus 1400 with the plurality of conventional inserts. A plot line 1504a shows that the coefficient of utilization for the light on the street side 1502da of the conventional light providing apparatus 1400 with the plurality of conventional inserts is approximately 35.9% at a street width divided by mounting height of approximately 5. A plot line 1504b shows that the coefficient of utilization for the light on the house side 1502db of the conventional light providing apparatus 1400 with the plurality of conventional inserts is approximately 26.5% at a street width divided by mounting height of approximately 5. Thus, the efficiency graph 1504 shows that the conventional light providing apparatus 1400 with the plurality of conventional inserts has a total efficiency of approximately 62.4% at a street width divided by mounting height of approximately 5.

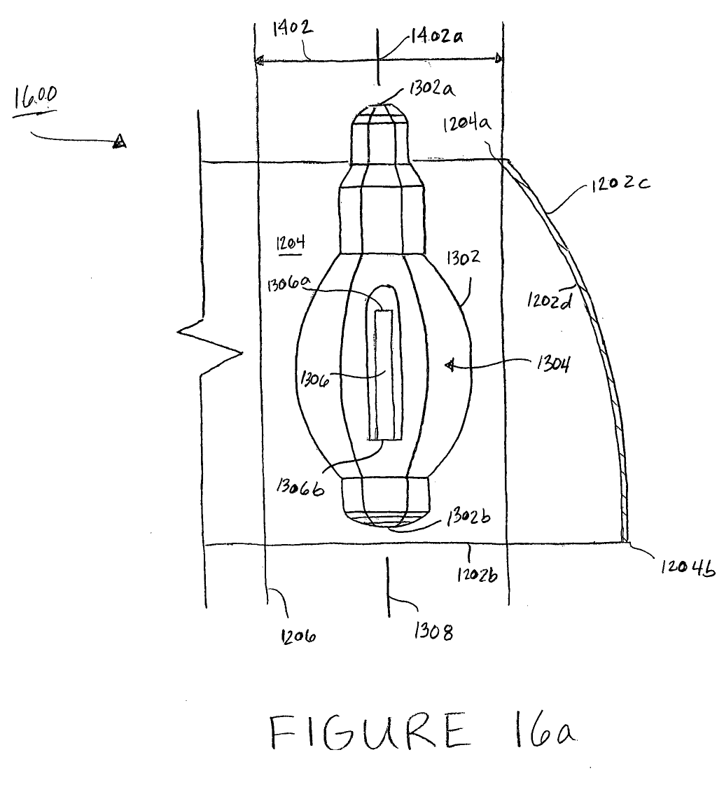

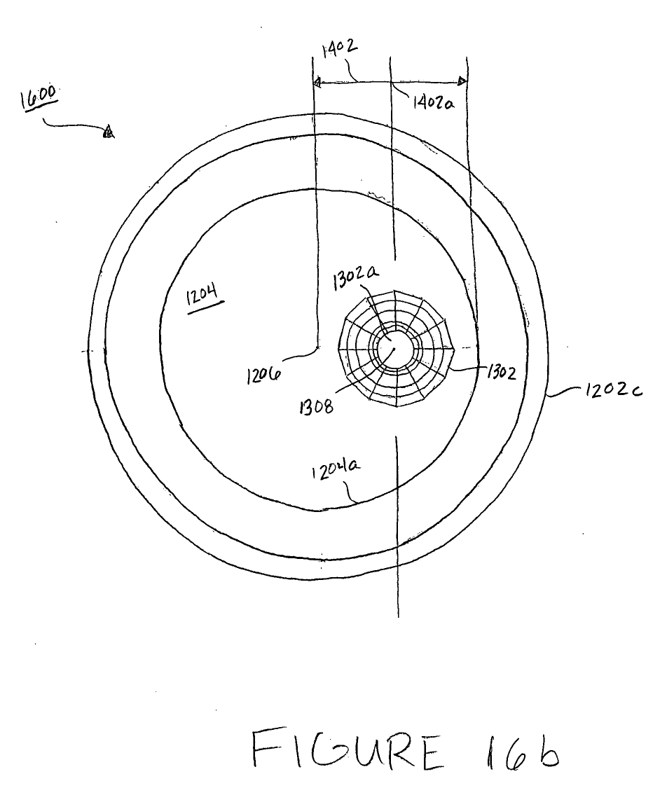

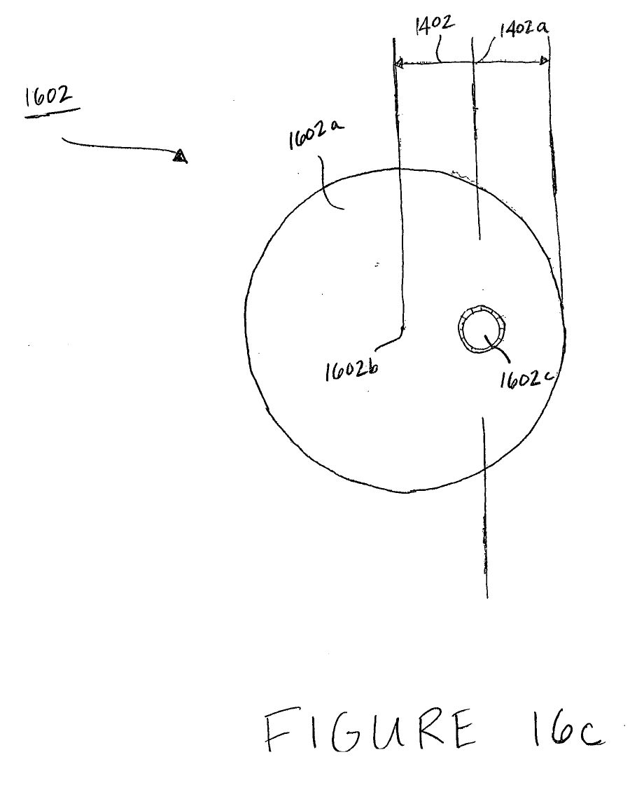

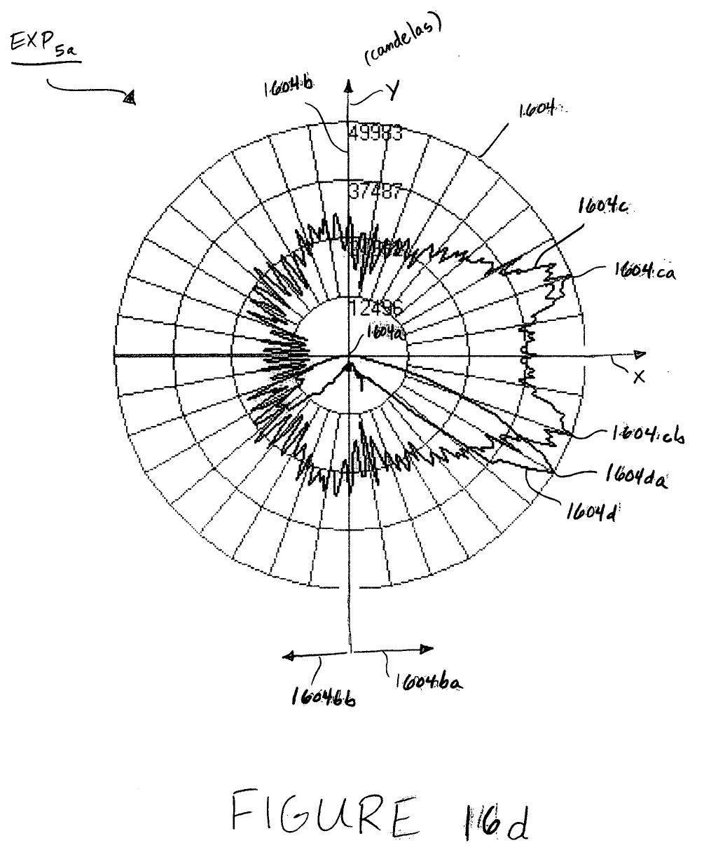

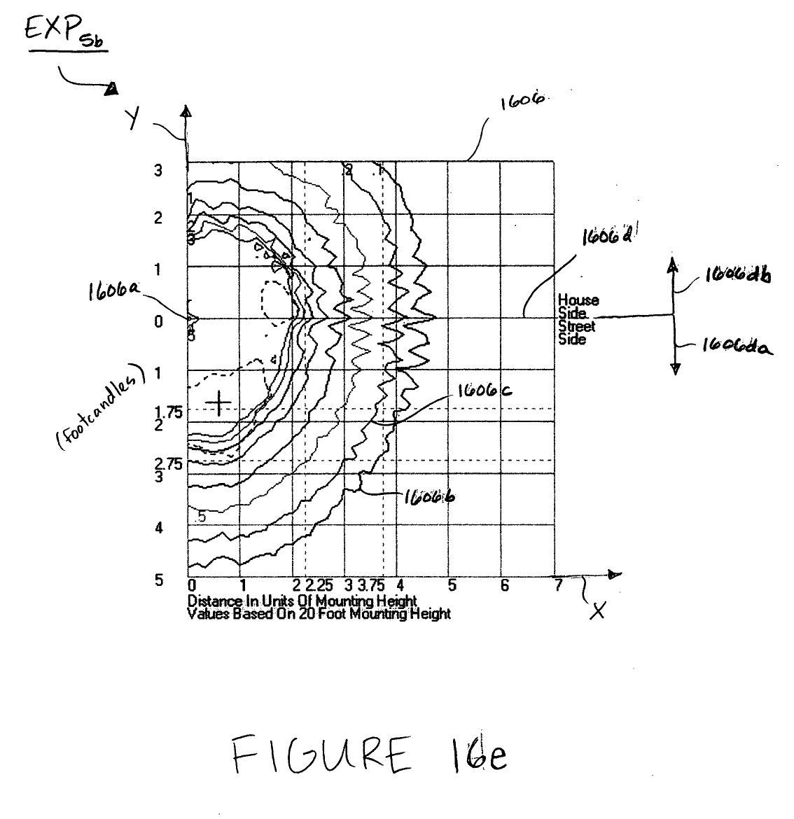

Referring now to FIGS. 12a, 12b, 13, 14c, 14d, 16a, 16b, and 16c, a light providing apparatus 1600 is illustrated. The light source 1300, described above with reference to FIG. 13, is positioned in the concave reflector 1200 in a spaced apart relationship from the reflector axis 1206. The light source 1300 is positioned in the light source housing 1204 such that the light source axis 1308 is substantially parallel to the reflector axis 1206 and positioned at the half top opening position 1402a, approximately halfway between the reflector axis 1206 and top opening 1204a, as illustrated in FIGS. 16a and 16b. In an exemplary embodiment, the light source 1300 is positioned in the concave reflector 1200 such that the arc tube 1306 is approximately positioned at the half radius of the concave reflector 1200. In an exemplary embodiment, the concave reflector 1200 includes a light source coupling device such as, for example, the light source coupling device 1602, illustrated in FIG. 16c but which has been omitted for clarity in FIGS. 16a and 16b, located adjacent the top edge 1202a of the base 1202 for positioning the light source 1300 in the concave reflector 1200. The light source coupling device 1602 includes a circular base 1602a having an axis 1602b, and a light source socket 1602c which is located in a spaced apart relationship from the axis 1602b and positioned approximately half the distance 1402 from the axis 1602b, as illustrated in FIG. 16c.

Referring now to FIG. 16d, in an experimental embodiment EXP₅ₐ, a candela plot 1604 is illustrated. The candela plot 1604 of experimental embodiment EXP₅ₐ shows the light distribution for the light providing apparatus 1600, described above with reference to FIGS. 16a and 16b. In the candela plot 1604 of experimental embodiment EXP₅ₐ, the light providing apparatus 1600 is centered at point 1604a, and different luminous intensities of the light provided by the light providing apparatus 1600 are recorded in different planes. A vertical line 1604b on the candela plot 1604 of experimental embodiment EXP₅ₐ separates a street side 1604ba of the light providing apparatus 1600 from a house side 1604bb of the light providing apparatus 1600. A plot line 1604c is the luminous intensity of the light in a plane looking down on the light providing apparatus 1600 from above. The plot line 1604c shows that the luminous intensity of the light provided by the light providing apparatus 1600 provides an asymmetrical light distribution such that more light is provided on the street side 1604ba of the light providing apparatus 1600 than is on the house side 1604bb of the light providing apparatus 1600, with a peak 1604ca and a peak 1604cb at approximately 20 degrees on either side of an X axis. This was an unexpected result. A plot line 1604d is the luminous intensity of the light in a plane looking at the light providing apparatus 1600 from the side of the light providing apparatus 1600. The plot line 1604d shows that the luminous intensity of the light provided by the light providing apparatus 1600 provides an asymmetrical light distribution such that more light is provided on the street side 1604ba of the light providing apparatus 1600 than is on the house side 1604bb of the light providing apparatus 1600, with a peak 1604da in the luminous intensity at approximately 60 degrees from the vertical line 1604b and on the street side 1604ba of the vertical line 1604b on the candela plot 1604 of experimental embodiment EXP₅ₐ. This was an unexpected result.

Referring now to FIG. 16e, in an experimental embodiment EXP_{5b}, an isofootcandle plot 1606 is illustrated. The isofootcandle plot 1606 of experimental embodiment EXP_{5b} shows the light pattern produced by the light providing apparatus 1600. In the isofootcandle plot 1606 of experimental embodiment EXP_{5b}, the light providing apparatus 1600 is centered at point 1606a, and isofootcandle lines such as, for example, line 1606b and line 1606c, plot equal footcandle levels when the light providing apparatus 1600 was mounted at a 20 foot mounting height. A horizontal line 1606d on the isofootcandle plot 1606 of experimental embodiment EXP_{5b} separates a street side 1606da of the light providing apparatus 1600 from a house side 1606db of the light providing apparatus 1600. The isofootcandle plot 1606 of experimental embodiment EXP_{5b} shows that the light providing apparatus 1600 produces asymmetrical isofootcandle lines which are non-circular and skewed towards the street side 1606da of light providing apparatus 1600. This was an unexpected result. In an exemplary embodiment, while outdoor lighting conventions and terms such as, for example, street side and house side, have been used in the discussion above, the light providing apparatus 1600 may be used, for example, indoors, outdoors, or in a variety of other locations known in the art.

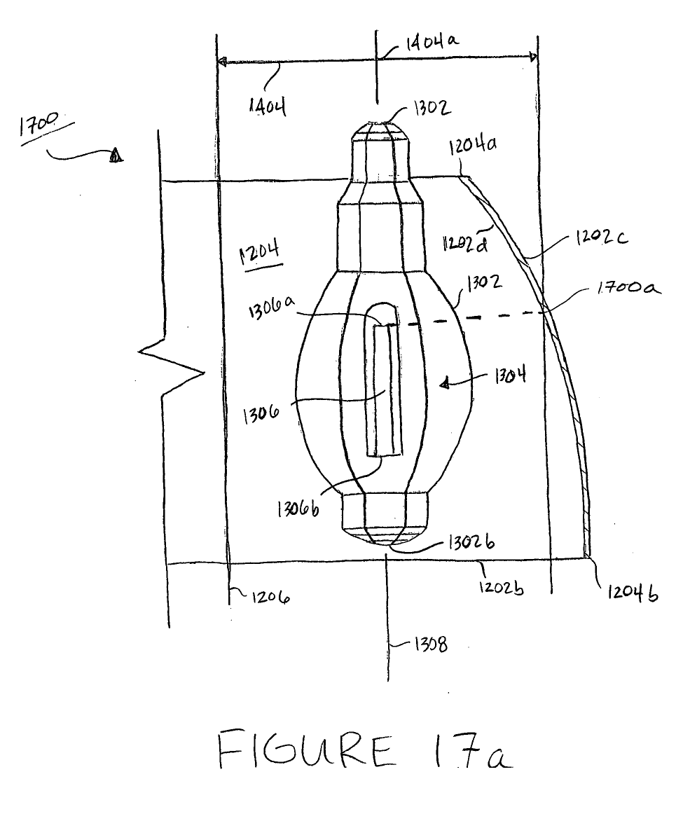

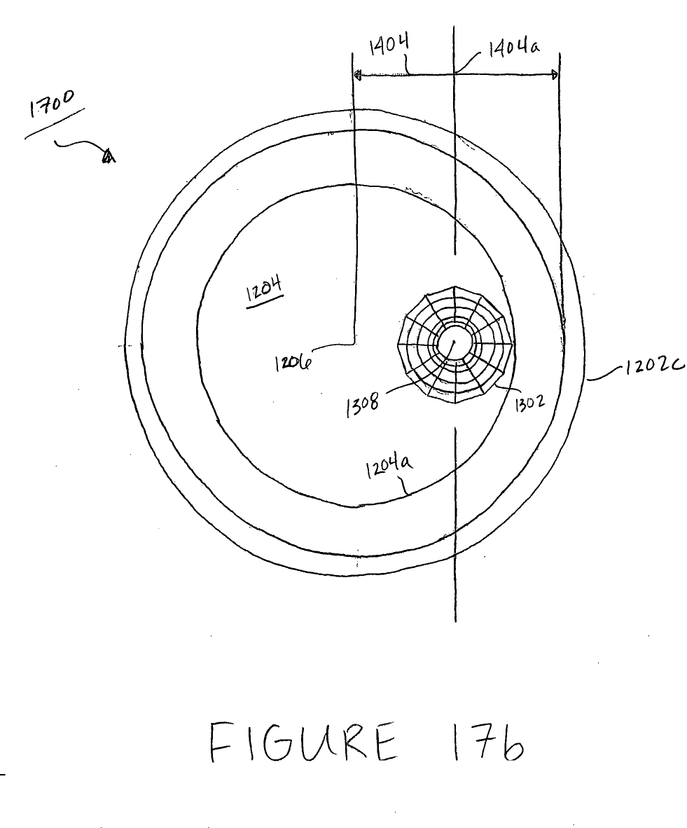

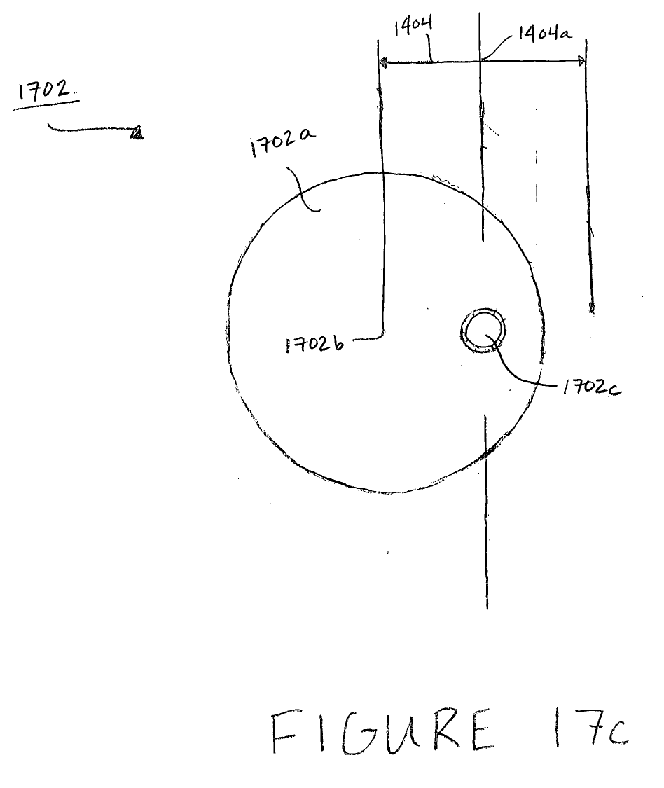

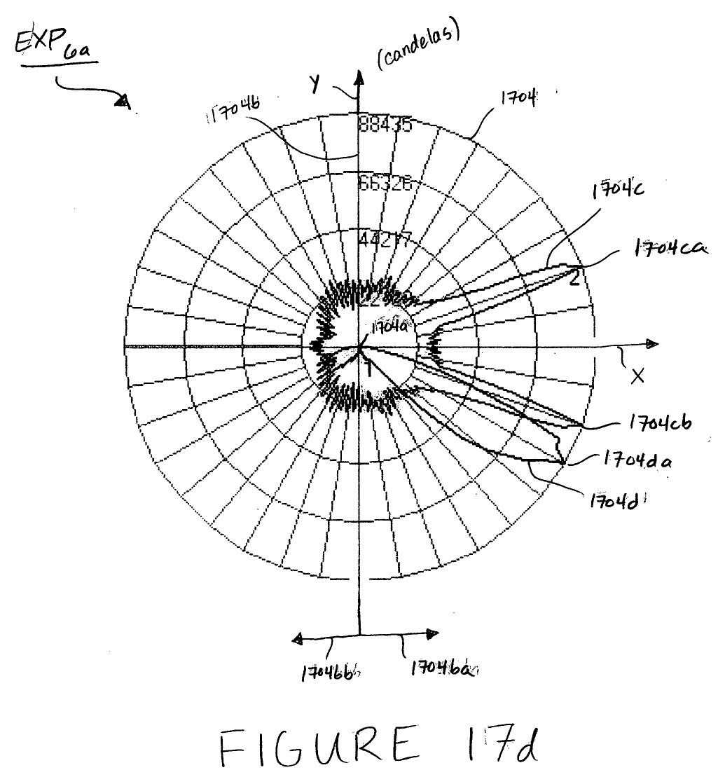

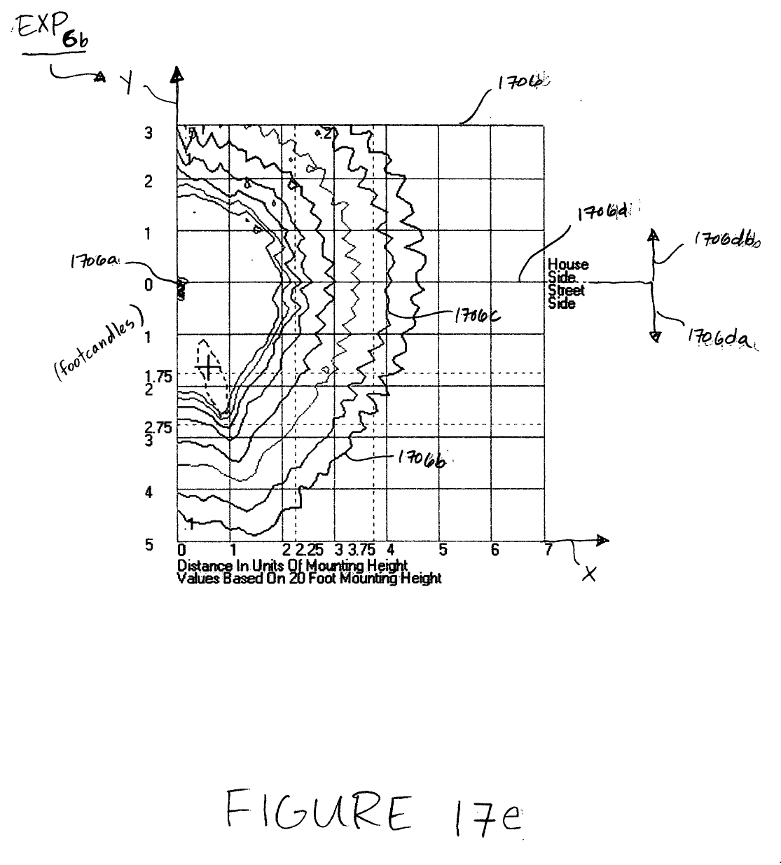

Referring now to FIGS. 12a, 12b, 13, 14c, 14d, 17a, 17b, and 17c, a light providing apparatus 1700 is illustrated. The light source 1300, described above with reference to FIG. 13, is positioned in the concave reflector 1200 in a spaced apart relationship from the reflector axis 1206. The light source 1300 is positioned in the light source housing 1204 such that the light source axis 1308 is substantially parallel to the reflector axis 1206 and positioned at the half top opening position 1404a, approximately halfway between the reflector axis 1206 and the intersection between a line which intersects the top of the arc tube 1306 and the inner surface 1202d of the concave reflector 1200, as illustrated in FIGS. 17a and 17b. In an exemplary embodiment, the light source 1300 is positioned in the concave reflector 1200 such that the arc tube 1306 is approximately positioned at the half radius of the concave reflector 1200. In an exemplary embodiment, the concave reflector 1200 includes a light source coupling device such as, for example, the light source coupling device 1702, illustrated in FIG. 17c but which has been omitted for clarity in FIGS. 17a and 17b, located adjacent the top edge 1202a of the base 1202 for positioning the light source 1300 in the concave reflector 1200. The light source coupling device 1702 includes a circular base 1702a having an axis 1702b, and a light source socket 1702c which is located in a spaced apart relationship from the axis 1702b and positioned approximately half the distance 1404 from the axis 1702b, as illustrated in FIG. 17c.

Referring now to FIG. 17d, in an experimental embodiment EXP₆ₐ, a candela plot 1704 is illustrated. The candela plot 1704 of experimental embodiment EXP₆ₐ shows the light distribution for the light providing apparatus 1700, described above with reference to FIGS. 17a and 17b. In the candela plot 1704 of experimental embodiment EXP₆ₐ, the light providing apparatus 1700 is centered at point 1704a, and different luminous intensities of the light provided by the light providing apparatus 1700 are recorded in different planes. A vertical line 1704b on the candela plot 1704 of experimental embodiment EXP₆ₐ separates a street side 1704ba of the light providing apparatus 1700 from a house side 1704bb of the light providing apparatus 1700. A plot line 1704c is the luminous intensity of the light in a plane looking down on the light providing apparatus 1700 from above. The plot line 1704c shows that the luminous intensity of the light provided by the light providing apparatus 1700 provides an asymmetrical light distribution such that more light is provided on the street side 1704ba of the light providing apparatus 1700 than is on the house side 1704bb of the light providing apparatus 1700, with a peak 1704ca and a peak 1704cb at approximately 20 degrees on either side of an X axis. This was an unexpected result. A plot line 1704d is the luminous intensity of the light in a plane looking at the light providing apparatus 1700 from the side of the light providing apparatus 1700. The plot line 1704d shows that the luminous intensity of the light provided by the light providing apparatus 1700 provides an asymmetrical light distribution such that more light is provided on the street side 1704ba of the light providing apparatus 1700 than is on the house side 1704bb of the light providing apparatus 1700, with a peak 1704da in the luminous intensity at approximately 60 degrees from the vertical line 1704b and on the street side 1704ba of the vertical line 1704b on the candela plot 1704 of experimental embodiment EXP₆ₐ. This was an unexpected result.

Referring now to FIG. 17e, in an experimental embodiment EXP_{6b}, an isofootcandle plot 1706 is illustrated. The isofootcandle plot 1706 of experimental embodiment EXP_{6b} shows the light pattern produced by the light providing apparatus 1700. In the isofootcandle plot 1706 of experimental embodiment EXP_{6b}, the light providing apparatus 1700 is centered at point 1706a, and isofootcandle lines such as, for example, line 1706b and line 1706c, plot equal footcandle levels when the light providing apparatus 1700 was mounted at a 20 foot mounting height. A horizontal line 1706d on the isofootcandle plot 1706 of experimental embodiment EXP_{6b} separates a street side 1706da of the light providing apparatus 1700 from a house side 1706db of the light providing apparatus 1700. The isofootcandle plot 1706 of experimental embodiment EXP_{6b} shows that the light providing apparatus 1700 produces asymmetrical isofootcandle lines which are non-circular and skewed towards the street side 1706da of light providing apparatus 1700. This was an unexpected result. In an exemplary embodiment, while outdoor lighting conventions and terms such as, for example, street side and house side, have been used in the discussion above, the light providing apparatus 1700 may be used, for example, indoors, outdoors, or in a variety of other locations known in the art.

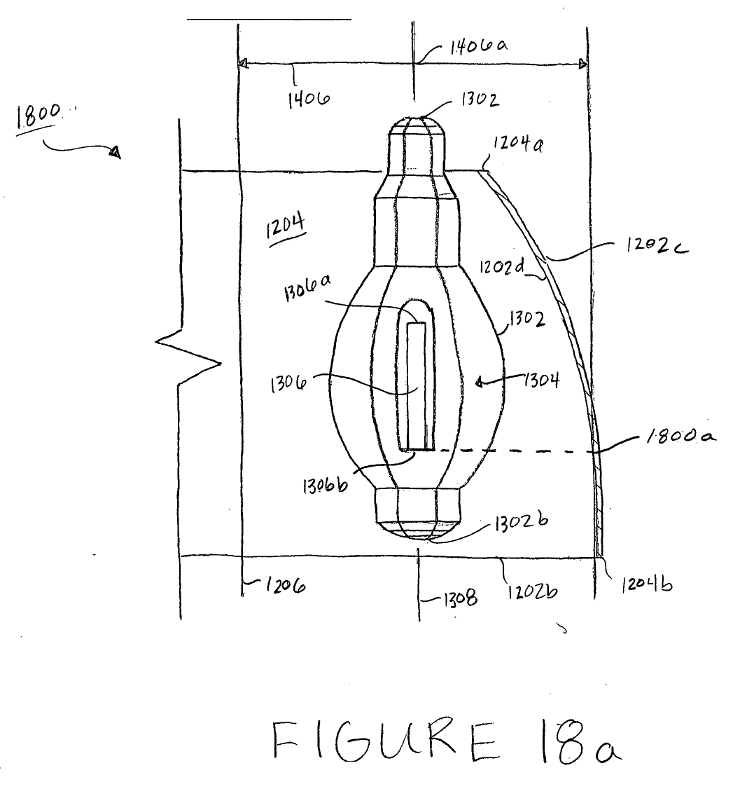

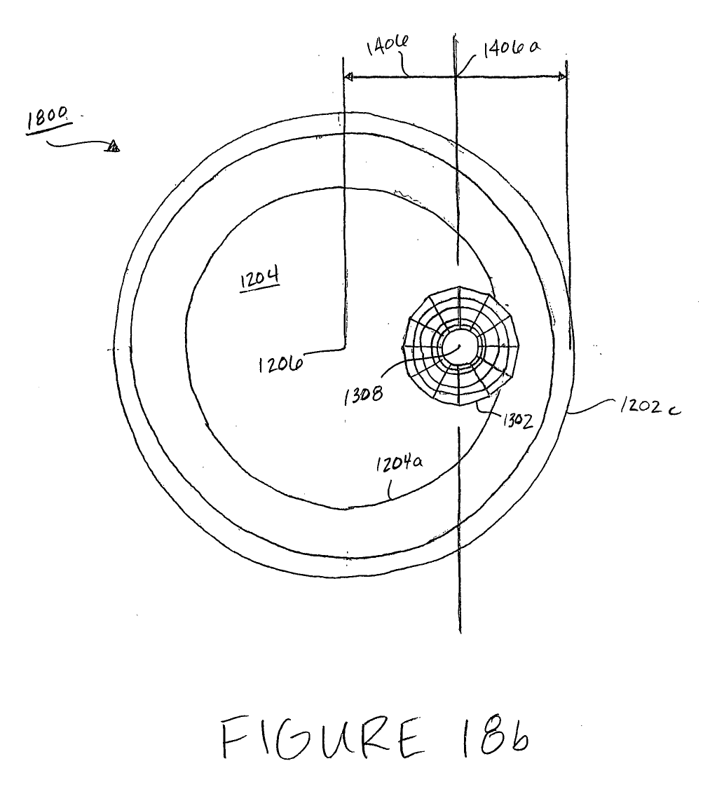

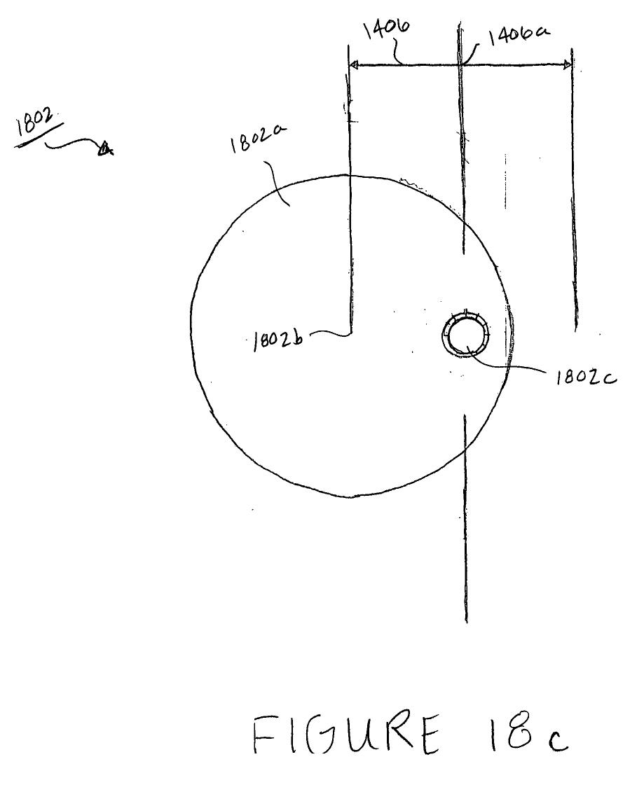

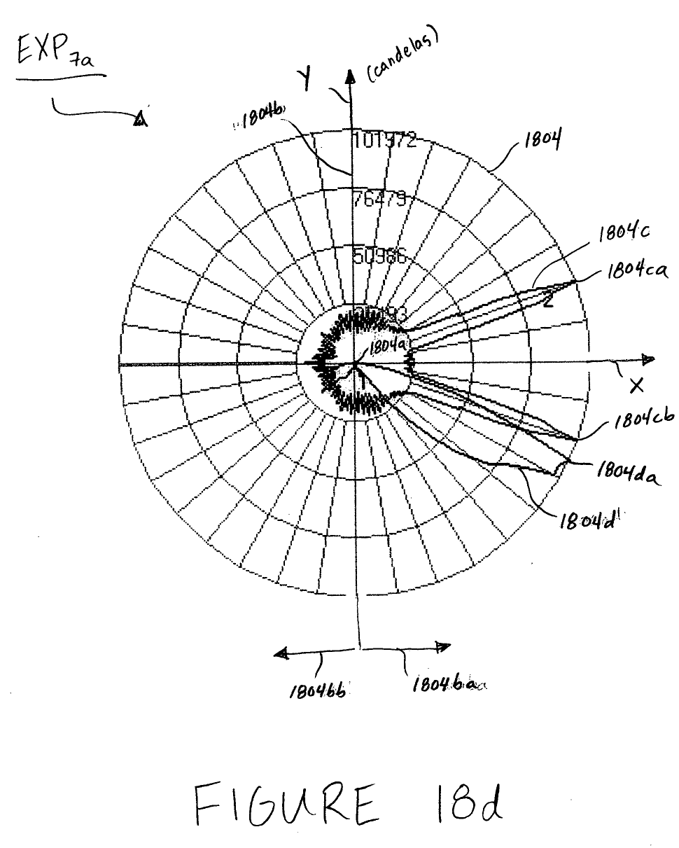

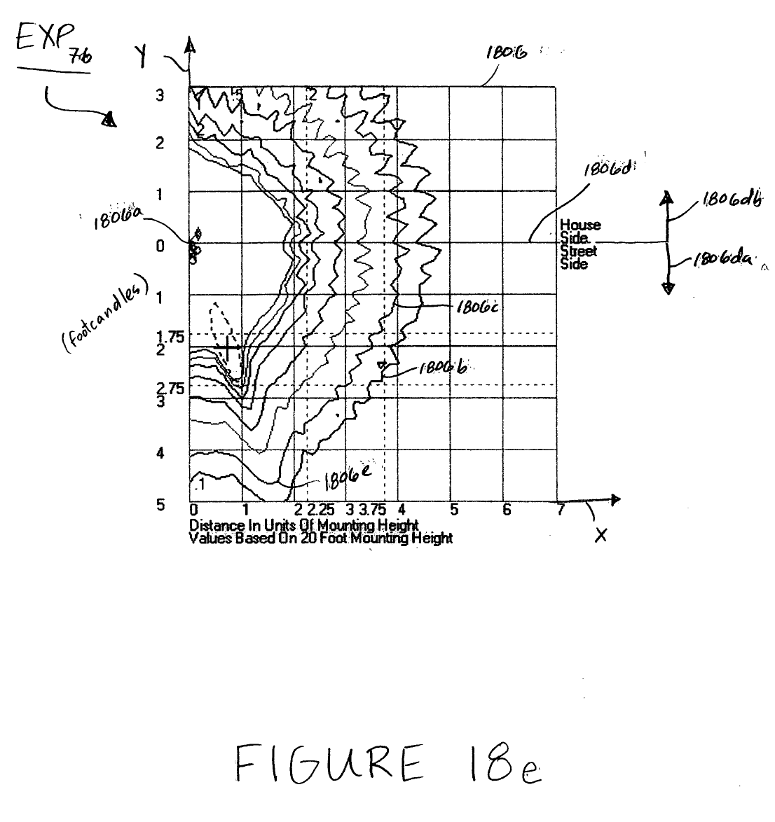

Referring now to FIGS. 12a, 12b, 13, 14c, 14d, 18a, 18b, and 18c, a light providing apparatus 1800 is illustrated. The light source 1300, described above with reference to FIG. 13, is positioned in the concave reflector 1200 in a spaced apart relationship from the reflector axis 1206. The light source 1300 is positioned in the light source housing 1204 such that the light source axis 1308 is substantially parallel to the reflector axis 1206 and positioned at the half top opening position 1406a, approximately halfway between the reflector axis 1206 and a line 1800a which intersects the bottom end of the arc tube 1306 and the inner surface 1202d of the concave reflector 1200, as illustrated in FIGS. 18a and 18b. In an exemplary embodiment, the light source 1300 is positioned in the concave reflector 1200 such that the arc tube 1306 is approximately positioned at the half radius of the concave reflector 1200. In an exemplary embodiment, the concave reflector 1200 includes a light source coupling device such as, for example, the light source coupling device 1802, illustrated in FIG. 18c but which has been omitted for clarity in FIGS. 18a and 18b, located adjacent the top edge 1202a of the base 1202 for positioning the light source 1300 in the concave reflector 1200. The light source coupling device 1802 includes a circular base 1802a having an axis 1802b, and a light source socket 1802c which is located in a spaced apart relationship from the axis 1802b and positioned approximately half the distance 1406 from the axis 1802b, as illustrated in FIG. 18c.

Referring now to FIG. 18d, in an experimental embodiment EXP₇ₐ, a candela plot 1804 is illustrated. The candela plot 1804 of experimental embodiment EXP₇ₐ shows the light distribution for the light providing apparatus 1800, described above with reference to FIGS. 18a and 18b. In the candela plot 1804 of experimental embodiment EXP₇ₐ, the light providing apparatus 1800 is centered at point 1804a, and different luminous intensities of the light provided by the light providing apparatus 1800 are recorded in different planes. A vertical line 1804b on the candela plot 1804 of experimental embodiment EXP₇ₐ separates a street side 1804ba of the light providing apparatus 1800 from a house side 1804bb of the light providing apparatus 1800. A plot line 1804c is the luminous intensity of the light in a plane looking down on the light providing apparatus 1800 from above. The plot line 1804c shows that the luminous intensity of the light provided by the light providing apparatus 1800 provides an asymmetrical light distribution such that more light is provided on the street side 1804ba of the light providing apparatus 1800 than is on the house side 1804bb of the light providing apparatus 1800, with a peak 1804ca and a peak 1804cb at approximately 20 degrees on either side of an X axis. This was an unexpected result. A plot line 1804d is the luminous intensity of the light in a plane looking at the light providing apparatus 1800 from the side of the light providing apparatus 1800. The plot line 1804d shows that the luminous intensity of the light provided by the light providing apparatus 1800 provides an asymmetrical light distribution such that more light is provided on the street side 1804ba of the light providing apparatus 1800 than is on the house side 1804bb of the light providing apparatus 1800, with a peak 1804da in the luminous intensity at approximately 60 degrees from the vertical line 1804b and on the street side 1804ba of the vertical line 1804b on the candela plot 1804 of experimental embodiment EXP₇ₐ. This was an unexpected result.

Referring now to FIG. 18e, in an experimental embodiment EXP_{7b}, an isofootcandle plot 1806 is illustrated. The isofootcandle plot 1806 of experimental embodiment EXP_{7b} shows the light pattern produced by the light providing apparatus 1800. In the isofootcandle plot 1806 of experimental embodiment EXP_{7b}, the light providing apparatus 1800 is centered at point 1806a, and isofootcandle lines such as, for example, line 1806b and line 1806c, plot equal footcandle levels when the light providing apparatus 1800 was mounted at a 20 foot mounting height. A horizontal line 1806d on the isofootcandle plot 1806 of experimental embodiment EXP_{7b} separates a street side 1806da of the light providing apparatus 1800 from a house side 1806db of the light providing apparatus 1800. The isofootcandle plot 1806 of experimental embodiment EXP_{7b} shows that the light providing apparatus 1800 produces asymmetrical isofootcandle lines which are non-circular and skewed towards the street side 1806da of light providing apparatus 1800, and includes a light corner 1806e. This was an unexpected result. In an exemplary embodiment, while outdoor lighting conventions and terms such as, for example, street side and house side, have been used in the discussion above, the light providing apparatus 1800 may be used, for example, indoors, outdoors, or in a variety of other locations known in the art.

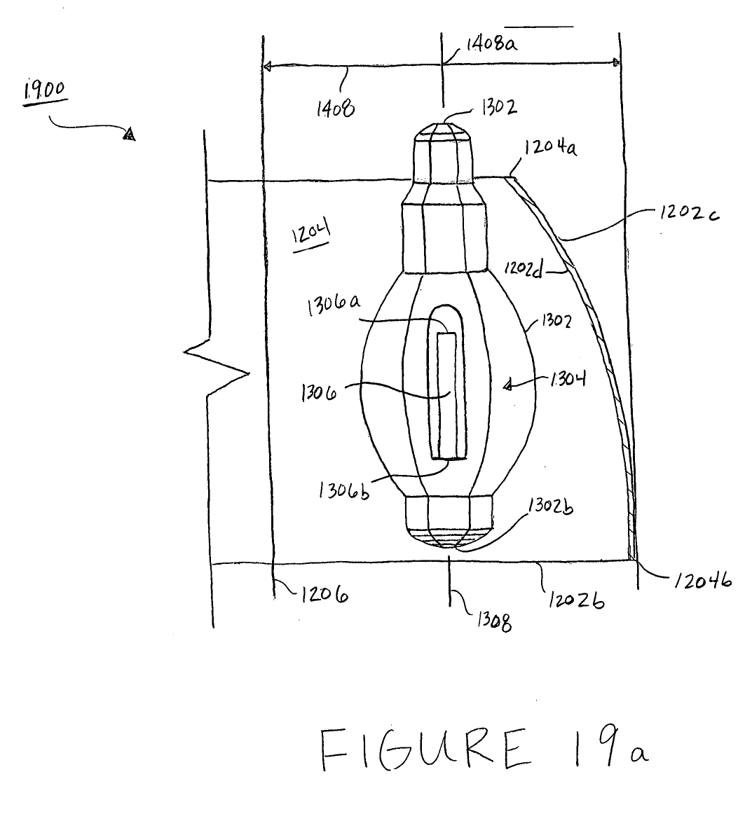

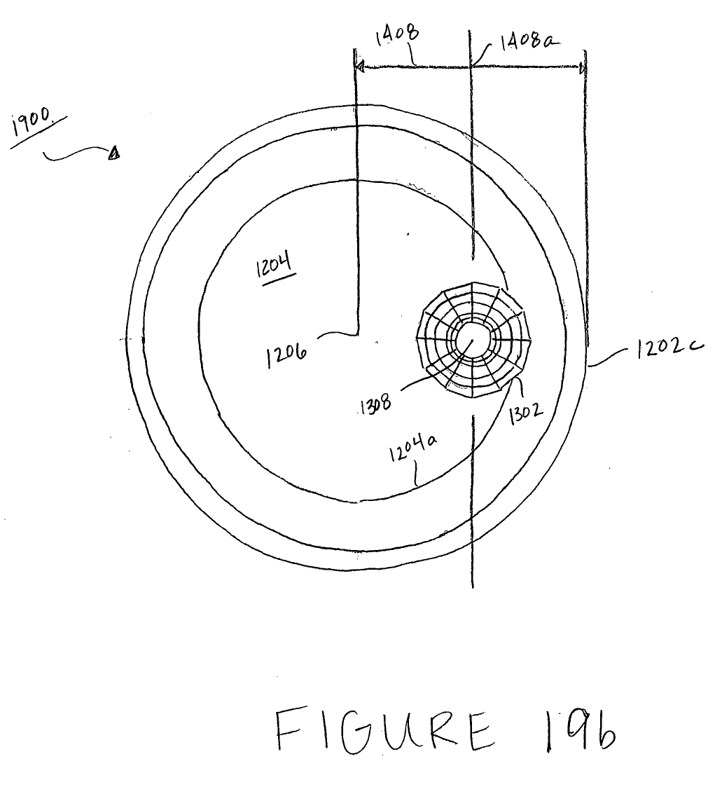

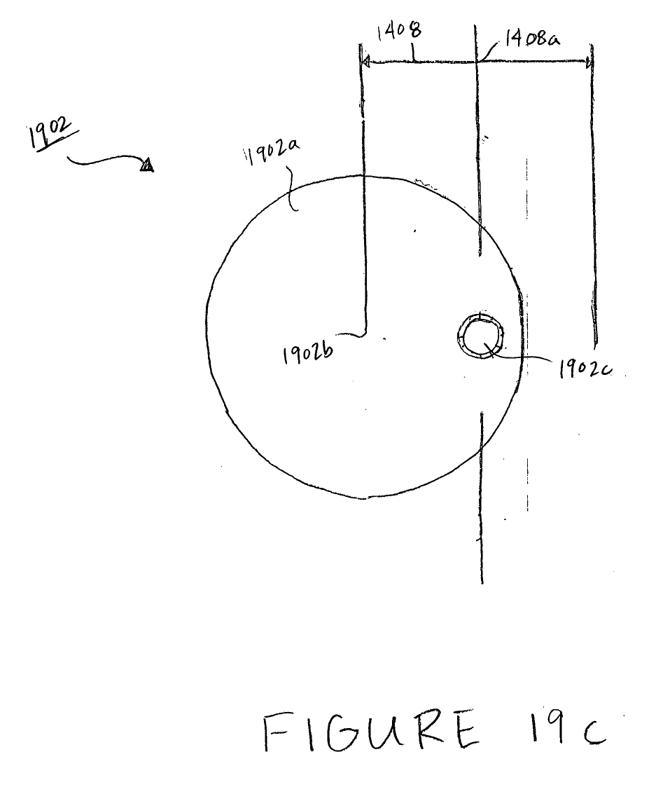

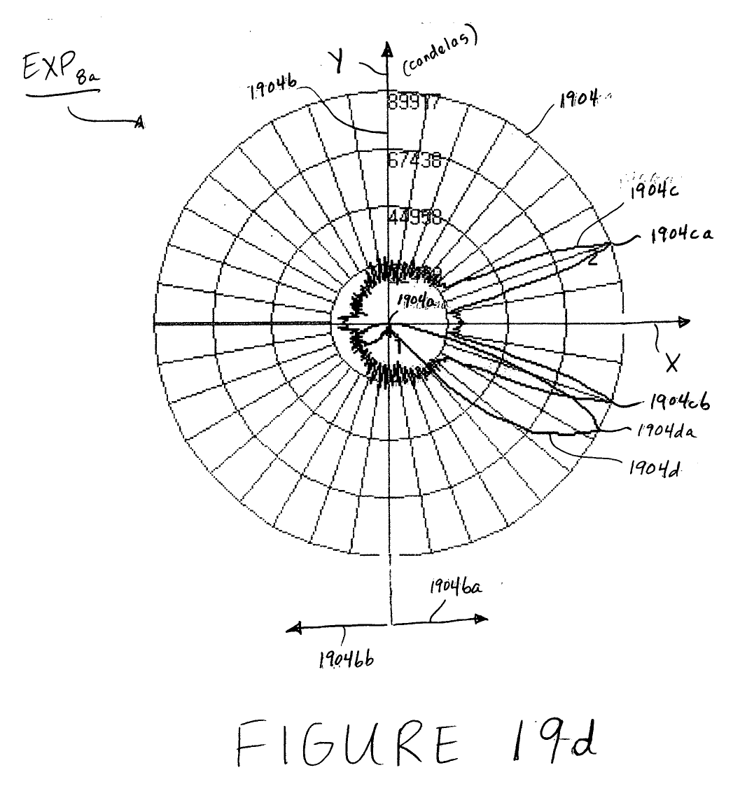

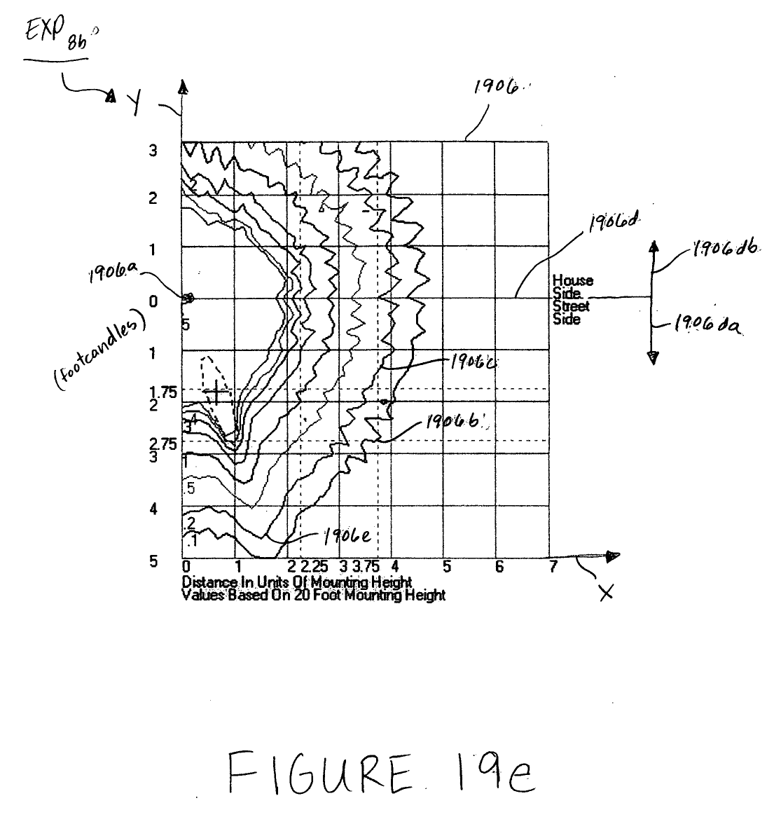

Referring now to FIGS. 12a, 12b, 13, 14c, 14d, 19a, 19b, and 19c, a light providing apparatus 1900 is illustrated. The light source 1300, described above with reference to FIG. 13, is positioned in the concave reflector 1200 in a spaced apart relationship from the reflector axis 1206. The light source 1300 is positioned in the light source housing 1204 such that the light source axis 1308 is substantially parallel to the reflector axis 1206 and positioned at the half top opening position 1408a, approximately halfway between the reflector axis 1206 and the bottom opening 1204b, as illustrated in FIGS. 19a and 19b. In an exemplary embodiment, the light source 1300 is positioned in the concave reflector 1200 such that the arc tube 1306 is approximately positioned at the half radius of the concave reflector 1200. In an exemplary embodiment, the concave reflector 1200 includes a light source coupling device such as, for example, the light source coupling device 1902, illustrated in FIG. 19c but which has been omitted for clarity in FIGS. 19a and 19b, located adjacent the top edge 1202a of the base 1202 for positioning the light source 1300 in the concave reflector 1200. The light source coupling device 1902 includes a circular base 1902a having an axis 1902b, and a light source socket 1902c which is located in a spaced apart relationship from the axis 1902b and positioned approximately half the distance 1408 from the axis 1902b, as illustrated in FIG. 19c.

Referring now to FIG. 19d, in an experimental embodiment EXP₈ₐ, a candela plot 1904 is illustrated. The candela plot 1904 of experimental embodiment EXP₈ₐ shows the light distribution for the light providing apparatus 1900, described above with reference to FIGS. 19a and 19b. In the candela plot 1904 of experimental embodiment EXP₈ₐ, the light providing apparatus 1900 is centered at point 1904a, and different luminous intensities of the light provided by the light providing apparatus 1900 are recorded in different planes. A vertical line 1904b on the candela plot 1904 of experimental embodiment EXP₈ₐ separates a street side 1904ba of the light providing apparatus 1900 from a house side 1904bb of the light providing apparatus 1900. A plot line 1904c is the luminous intensity of the light in a plane looking down on the light providing apparatus 1900 from above. The plot line 1904c shows that the luminous intensity of the light provided by the light providing apparatus 1900 provides an asymmetrical light distribution such that more light is provided on the street side 1904ba of the light providing apparatus 1900 than is on the house side 1904bb of the light providing apparatus 1900, with a peak 1904ca and a peak 1904cb at approximately 20 degrees on either side of an X axis. This was an unexpected result. A plot line 1904d is the luminous intensity of the light in a plane looking at the light providing apparatus 1900 from the side of the light providing apparatus 1900. The plot line 1904d shows that the luminous intensity of the light provided by the light providing apparatus 1900 provides an asymmetrical light distribution such that more light is provided on the street side 1904ba of the light providing apparatus 1900 than is on the house side 1904bb of the light providing apparatus 1900, with a peak 1904da in the luminous intensity at approximately 60 degrees from the vertical line 1904b and on the street side 1904ba of the vertical line 1904b on the candela plot 1904 of experimental embodiment EXP₈ₐ. This was an unexpected result.

Referring now to FIG. 19e, in an experimental embodiment EXP_{8b}, an isofootcandle plot 1906 is illustrated. The isofootcandle plot 1906 of experimental embodiment EXP_{8b} shows the light pattern produced by the light providing apparatus 1900. In the isofootcandle plot 1906 of experimental embodiment EXP_{8b}, the light providing apparatus 1900 is centered at point 1906a, and isofootcandle lines such as, for example, line 1906b and line 1906c, plot equal footcandle levels when the light providing apparatus 1900 was mounted at a 20 foot mounting height. A horizontal line 1906d on the isofootcandle plot 1906 of experimental embodiment EXP_{8b} separates a street side 1906da of the light providing apparatus 1900 from a house side 1906db of the light providing apparatus 1900. The isofootcandle plot 1906 of experimental embodiment EXP_{8b} shows that the light providing apparatus 1900 produces asymmetrical isofootcandle lines which are non-circular and skewed towards the street side 1906da of light providing apparatus 1900, and includes a light corner 1906e. This was an unexpected result. In an exemplary embodiment, while outdoor lighting conventions and terms such as, for example, street side and house side, have been used in the discussion above, the light providing apparatus 1900 may be used, for example, indoors, outdoors, or in a variety of other locations known in the art.

Referring now to FIGS. 12a, 12b, 13, 14c, 14d, 16b, 16c, 20a, and 20b, a light providing apparatus 2000 is illustrated. The light source 1300, described above with reference to FIG. 13, is positioned in the concave reflector 1200 in a spaced apart relationship from the reflector axis 1206. The light source 1300 is positioned in the light source housing 1204 such that the light source axis 1308 is substantially parallel to the reflector axis 1206 and positioned at the half top opening position 1402a, approximately halfway between the reflector axis 1206 and top opening 1204a, as illustrated in FIGS. 16a and 16b. In an exemplary embodiment, the light source 1300 is positioned in the concave reflector 1200 such that the arc tube 1306 is approximately positioned at the half radius of the concave reflector 1200. In an exemplary embodiment, the concave reflector 1200 includes a light source coupling device such as, for example, the light source coupling device 1602, illustrated in FIG. 16c but which has been omitted for clarity in FIGS. 16a and 16b, located adjacent the top edge 1202a of the base 1202 for positioning the light source 1300 in the concave reflector 1200. The light source coupling device 1602 includes a circular base 1602a having an axis 1602b, and a light source socket 1602c which is located in a spaced apart relationship from the axis 1602b and positioned approximately half the distance 1402 from the axis 1602b, as illustrated in FIG. 16c.

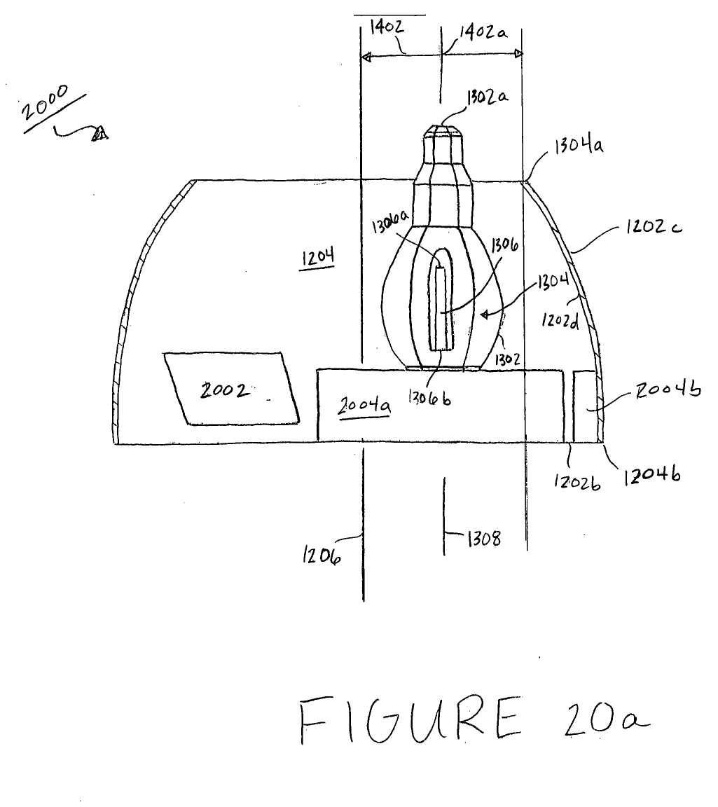

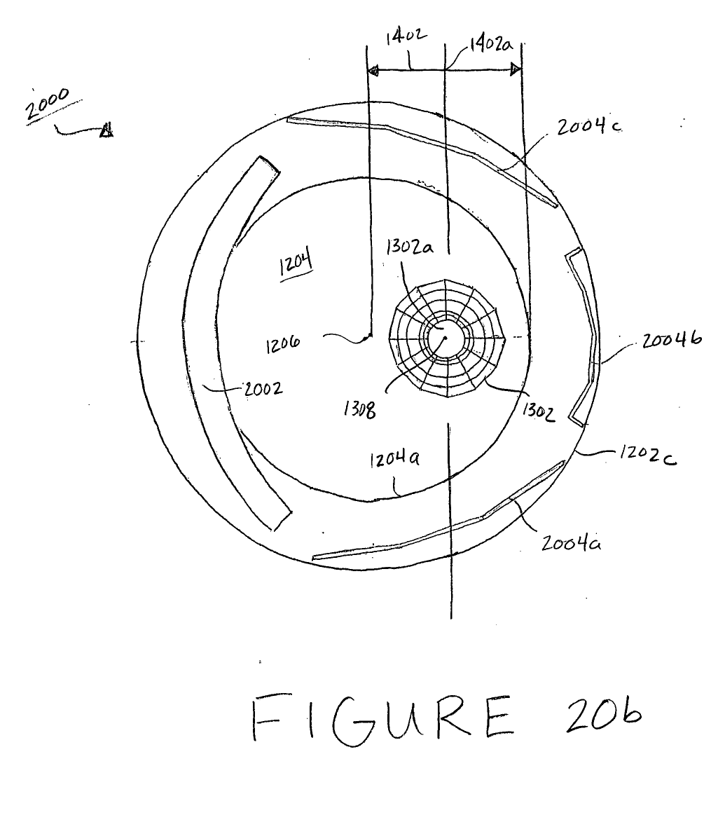

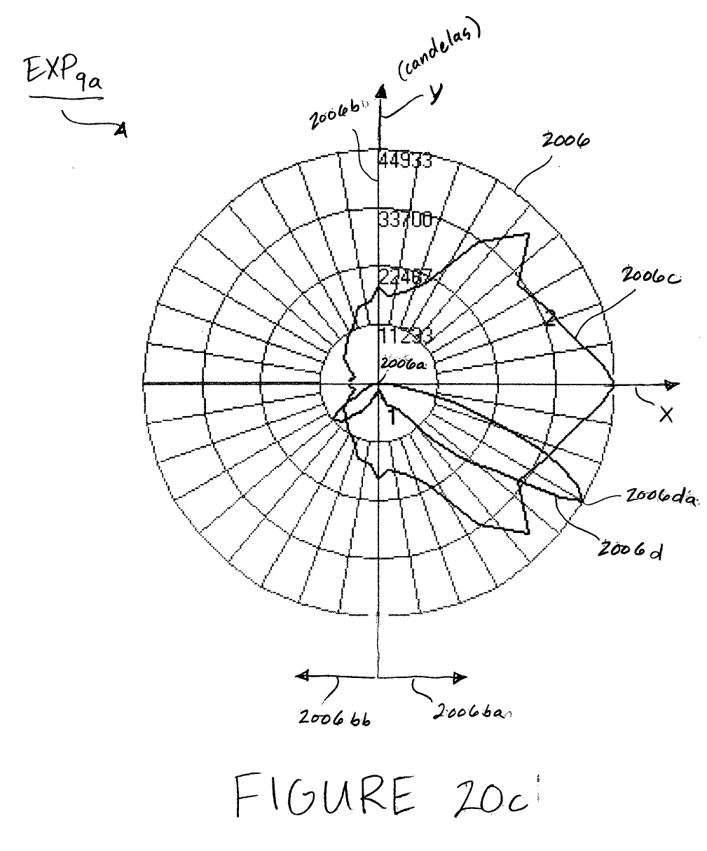

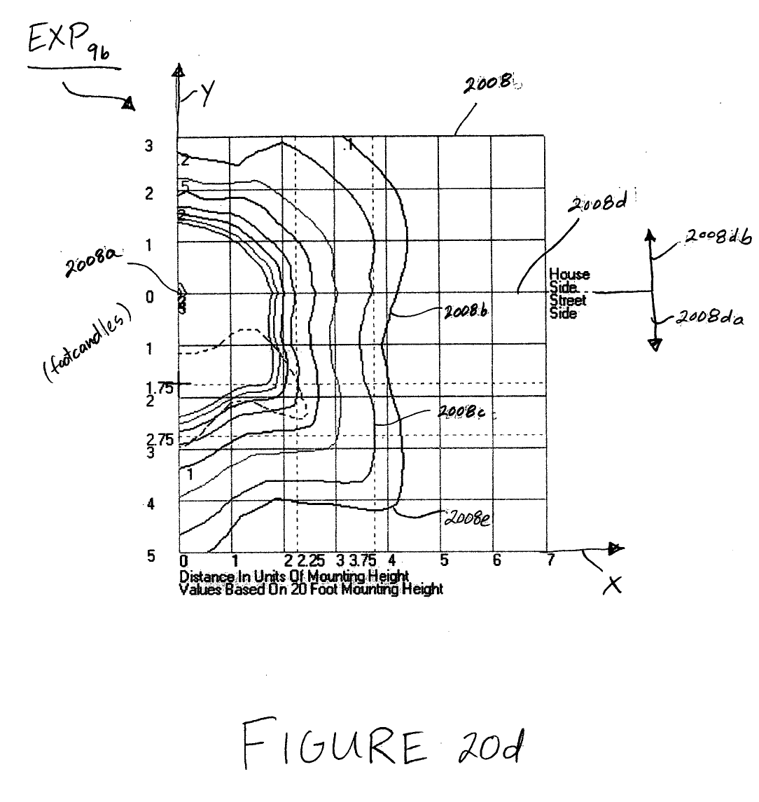

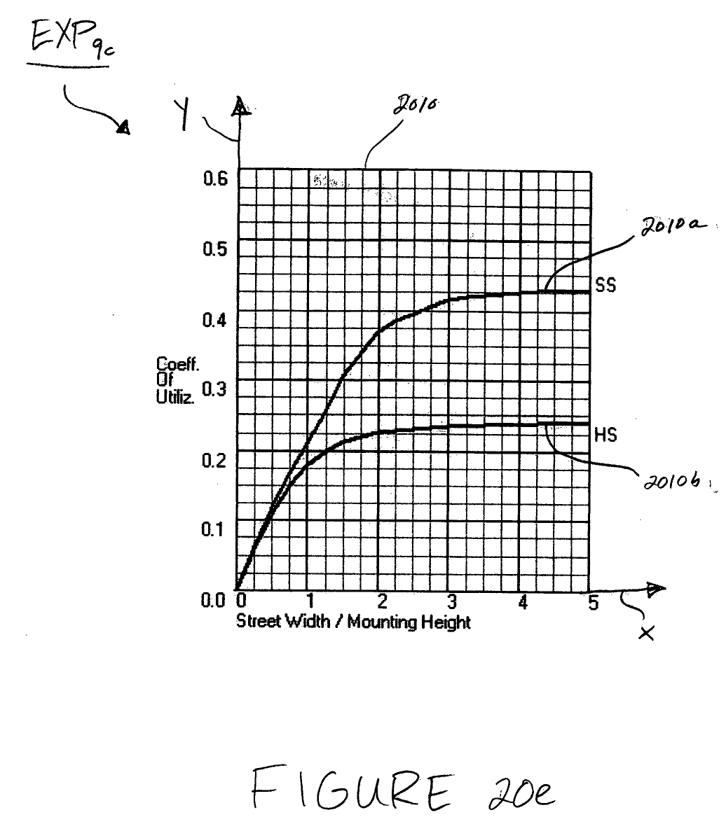

A conventional arcuate house side reflector 2002 is then coupled to the inner surface 1202d of the concave reflector 1200 and opposite the reflector axis 1206 from the light source 1300, as illustrated in FIGS. 20a and 20b. A plurality of conventional faceted inserts 2004a, 2004b, and 2004c, are coupled to the inner surface 1202d of the concave reflector 1200 and adjacent the light source 1300, as illustrated in FIGS. 20a and 20b.

Referring now to FIG. 20c, in an experimental embodiment EXP₉ₐ, a candela plot 2006 is illustrated. The candela plot 2006 of experimental embodiment EXP₉ₐ shows the light distribution for the light providing apparatus 2000, described above with reference to FIGS. 20a and 20b. In the candela plot 2006 of experimental embodiment EXP₉ₐ, the light providing apparatus 2000 is centered at point 2006a, and different luminous intensities of the light provided by the light providing apparatus 2000 are recorded in different planes. A vertical line 2006b on the candela plot 2006 of experimental embodiment EXP₉ₐ separates a street side 2006ba of the light providing apparatus 2000 from a house side 2006bb of the light providing apparatus 2000. A plot line 2006b is the luminous intensity of the light in a plane looking down on the light providing apparatus 2000 from above. The plot line 2006c shows that the luminous intensity of the light provided by the light providing apparatus 2000 provides an asymmetrical light distribution such that more light is provided on the street side 2006ba of the light providing apparatus 2000 than is on the house side 2006bb of the light providing apparatus 2000. This was an unexpected result. A plot line 2006d is the luminous intensity of the light in a plane looking at the light providing apparatus 2000 from the side of the light providing apparatus 2000. The plot line 2006d shows that the luminous intensity of the light provided by the light providing apparatus 2000 provides an asymmetrical light distribution such that more light is provided on the street side 2006ba of the light providing apparatus 2000 than is on the house side 2006bb of the light providing apparatus 2000, with a peak 2006da in the luminous intensity at approximately 60 degrees from the vertical line 1808ab and on the street side 1808aba of the vertical line 1808ab on the candela plot 2006b of experimental embodiment EXP₉ₐ. This was an unexpected result. Furthermore, comparing the candela plot 2006 for the light providing apparatus 2000 to the candela plot 1604 for the light providing apparatus 1600, the house side reflector 2002 reduces luminous intensity on the house side 2006ba of the light providing apparatus 1600 and increases luminous intensity on the street side 2006bb of the light providing apparatus 1604, while the inserts 2004a, 2004b, and 2004c flatten out the luminous intensity distribution.

Referring now to FIG. 20d, in an experimental embodiment EXP_{9b}, an isofootcandle plot 2008 is illustrated. The isofootcandle plot 2008 of experimental embodiment EXP_{9b} shows the light pattern produced by the light providing apparatus 2000. In the isofootcandle plot 2008 of experimental embodiment EXP_{9b}, the light providing apparatus 2000 is centered at point 2008a, and isofootcandle lines such as, for example, line 2008b and line 2008c, plot equal footcandle levels when the light providing apparatus 2000 was mounted at a 20 foot mounting height. A horizontal line 2008d on the isofootcandle plot 2008 of experimental embodiment EXP_{9b} separates a street side 2008da of the light providing apparatus 2000 from a house side 2008db of the light providing apparatus 2000. The isofootcandle plot 2008 of experimental embodiment EXP_{9b} shows that the light providing apparatus 2000 produces asymmetrical isofootcandle lines which are non-circular and skewed towards the street side 2008da of light providing apparatus 2000, and which include a light corner 2008e. This was an unexpected result. Furthermore, comparing the isofootcandle plot 2008 for the light providing apparatus 2000 to the isofootcandle plot 1606 for the light providing apparatus 1600, the house side reflector 2002 reduces luminous intensity on the house side 2008ab of the light providing apparatus 2000 and increases luminous intensity on the street side 2008da of the light providing apparatus 2000, while the inserts 2004a, 2004b, and 2004c flatten out the luminous intensity distribution. In an exemplary embodiment, while outdoor lighting conventions and terms such as, for example, street side and house side, have been used in the discussion above, the light providing apparatus 2000 may be used, for example, indoors, outdoors, or in a variety of other locations known in the art.

Referring now to FIG. 20e, in an experimental embodiment EXP_{9c}, an efficiency graph 2010 is illustrated. The efficiency graph 2010 of experimental embodiment EXP_{9c} plots the coefficient of utilization for the light providing apparatus 2000. A plot line 2010a shows that the coefficient of utilization for the light on the street side of the light providing apparatus 2000 is approximately 43.2% at a street width divided by mounting height of approximately 5. Compared to the efficiency graph 1504 for the conventional light providing apparatus 1400 including the plurality of conventional inserts, described above with reference to FIG. 15c, this is an increase of approximately 7.3%. This was an unexpected result. A plot line 2010b shows that the coefficient of utilization for the light on the house side of the light providing apparatus 2000 is approximately 24.2% at a street width divided by mounting height of approximately 5. Compared to the efficiency graph 1504 for the conventional light providing apparatus 1400 including the plurality of conventional inserts, described above with reference to FIG. 15c, this is a decrease of approximately 2.3%. This was an unexpected result. Thus, the efficiency graph 2010 shows that the light providing apparatus 2000 has a total efficiency of approximately 67.4% at a street width divided by mounting height of approximately 5. Compared to the efficiency graph 1504 for the conventional light providing apparatus 1400 including the plurality of conventional inserts, described above with reference to FIG. 15c, this is an increase in efficiency of approximately 5.0%. This was an unexpected result.

A lighting apparatus has been described which includes a downlight cone comprising an inner reflective surface and defining a window, the window comprising a first zone defining a first angle, and a second zone defining a second angle. In an exemplary embodiment, the second angle is greater than the first angle. In an exemplary embodiment, the first angle ranges from about 90 degrees to about 130 degrees. In an exemplary embodiment, the second angle is about 180 degrees. In an exemplary embodiment, the downlight cone defines a longitudinal axis upon which the vertices of the first and second angles lie, and wherein the first angle lies on a first plane and the second angle lies on a second plane that is parallel to the first plane. In an exemplary embodiment, the window further includes a pair of symmetric contours extending between the first and second zones. In an exemplary embodiment, a first pair of symmetric points along the respective contours defines a third zone defining a third angle that is greater than the first angle and less than the second angle. In an exemplary embodiment, a second pair of symmetric points along the respective contours defines a fourth zone positioned between the first zone and the third zone, the fourth zone defining a fourth angle that is greater than the first angle and less than the third angle. In an exemplary embodiment, a second pair of symmetric points along the respective contours defines a fourth zone positioned between the third zone and the second zone, the fourth zone defining a fourth angle that is greater than the third angle and less than the second angle. In an exemplary embodiment the downlight cone defines a longitudinal axis upon which the vertices of the first and second angles lie, wherein the first angle lies on a first plane and the second angle lies on a second plane that is parallel to the first plane, wherein an array of angles is defined by the pair of symmetric contours, each angle in the array of angles being defined by a pair of symmetric points along the respective contours, each respective pair of points defining a directional distance between the points and the second zone that is parallel with the longitudinal axis, and wherein the size of each respective angle increases as each respective directional distance decreases. In an exemplary embodiment, the first angle ranges from about 90 degrees to about 130 degrees. In an exemplary embodiment, the second angle is about 180 degrees.

A method for providing light has been described which includes reflecting at least a portion of light from a light source to produce a scallop beam pattern on a surface, allowing at least another portion of light from the light source to be reflected to produce another beam pattern on the surface, and merging the scallop beam pattern and the other beam pattern to form a wash beam pattern. In an exemplary embodiment, the wash beam pattern defines a boundary, the boundary defining a substantially continuous curve. In an exemplary embodiment, the substantially continuous curve is substantially free of inflection points. In an exemplary embodiment, the other beam pattern is substantially trapezoidal in shape.

A lighting apparatus has been described which includes means for providing light, means for reflecting at least a portion of light from the means for providing light to produce a scallop beam pattern on a surface, and means for allowing at least another portion of light from the means for providing light to be reflected to produce another beam pattern on the surface, wherein the scallop beam pattern and the other beam pattern merge to form a wash beam pattern. In an exemplary embodiment, the wash beam pattern defines a boundary, the boundary defining a substantially continuous curve. In an exemplary embodiment, the substantially continuous curve is substantially free of inflection points. In an exemplary embodiment, the other beam pattern is substantially trapezoidal in shape.

A lighting apparatus has been described which includes a downlight cone defining a longitudinal axis and adapted to reflect at least a portion of light from a light source to produce a scallop beam pattern on a surface, a window defined by the downlight cone, the window including a first zone defining a first angle that ranges from about 90 degrees to about 130 degrees, the first angle lying on a first plane, a second zone defining a second angle that is about 180 degrees, the second angle lying on a second plane that is parallel to the first plane, wherein the vertices of the first and second angles lie on the longitudinal axis of the downlight cone, a pair of symmetric contours extending between the first and second zones, and an array of angles defined by the pair of symmetric contours, each angle in the array of angles being defined by a pair of symmetric points along the respective contours, each respective pair of points defining a directional distance between the points and the second zone that is parallel with the longitudinal axis of the downlight cone, wherein the size of each respective angle increases as each respective directional distance decreases.

A method for providing light has been described which includes reflecting at least a portion of light from a light source to produce a scallop beam pattern on a surface, allowing at least another portion of light from the light source to be reflected to produce a trapezoidal beam pattern on the surface, and merging the scallop beam pattern and the trapezoidal beam pattern to form a wash beam pattern, wherein the wash beam pattern defines a boundary, the boundary defining a substantially continuous curve, whereby the substantially continuous curve is substantially free of inflection points.

A lighting apparatus has been described which includes means for providing light, means for reflecting at least a portion of light from the means for providing light to produce a scallop beam pattern on a surface, and means for allowing at least another portion of light from the means for providing light to be reflected to produce a trapezoidal beam pattern on the surface, wherein the scallop beam pattern and the trapezoidal beam pattern merge to form a wash beam pattern, whereby the wash beam pattern defines a boundary, the boundary defining a substantially continuous curve which is substantially free of inflection points.

A lighting apparatus has been described which includes a downlight cone comprising an inner reflective surface and defining a window, the window including a first zone defining a first angle and a second zone defining a second angle, a light source coupling device coupled to the downlight cone, and a kicker reflector coupled to the downlight cone and positioned proximate the window. In an exemplary embodiment, the second angle is greater than the first angle. In an exemplary embodiment, the first angle ranges from about 90 degrees to about 130 degrees. In an exemplary embodiment, the second angle is about 180 degrees. In an exemplary embodiment, the downlight cone defines a longitudinal axis upon which the vertices of the first and second angles lie, and wherein the first angle lies on a first plane and the second angle lies on a second plane that is parallel to the first plane. In an exemplary embodiment, the window further includes a pair of symmetric contours extending between the first and second zones. In an exemplary embodiment, a first pair of symmetric points along the respective contours defines a third zone defining a third angle that is greater than the first angle and less than the second angle. In an exemplary embodiment, a second pair of symmetric points along the respective contours defines a fourth zone positioned between the first zone and the third zone, the fourth zone defining a fourth angle that is greater than the first angle and less than the third angle. In an exemplary embodiment, a second pair of symmetric points along the respective contours defines a fourth zone positioned between the third zone and the second zone, the fourth zone defining a fourth angle that is greater than the third angle and less than the second angle. In an exemplary embodiment, the downlight cone defines a longitudinal axis upon which the vertices of the first and second angles lie, wherein the first angle lies on a first plane and the second angle lies on a second plane that is parallel to the first plane, wherein an array of angles is defined by the pair of symmetric contours, each angle in the array of angles being defined by a pair of symmetric points along the respective contours, each respective pair of points defining a directional distance between the points and the second zone that is parallel with the longitudinal axis, and wherein the size of each respective angle increases as each respective directional distance decreases. In an exemplary embodiment, the first angle ranges from about 90 degrees to about 130 degrees. In an exemplary embodiment, the second angle is about 180 degrees. In an exemplary embodiment, the kicker reflector is adapted to reflect at least a portion of light from a light source to produce a kicker beam pattern on a surface. In an exemplary embodiment, the window further includes a pair of symmetric contours extending between the first and second zones, wherein the pair of symmetric contours at least partially defines the shape of the kicker beam pattern on the surface. In an exemplary embodiment, the kicker beam pattern is substantially trapezoidal in shape. In an exemplary embodiment, the downlight cone is adapted to reflect at least another portion of light from a light source to produce a scallop beam pattern on the surface, and wherein the kicker beam pattern merges with the scallop beam pattern to form a wash beam pattern defining a boundary. In an exemplary embodiment, the boundary defined by the wash beam pattern defines a substantially continuous curve that is substantially free of inflection points.

A method for providing light has been described which includes reflecting at least a portion of light from a light source to produce a scallop beam pattern on a surface, reflecting at least another portion of light from the light source to produce another beam pattern on the surface, and merging the scallop beam pattern and the other beam pattern to form a wash beam pattern. In an exemplary embodiment, the wash beam pattern defines a boundary, the boundary defining a substantially continuous curve. In an exemplary embodiment, the substantially continuous curve is substantially free of inflection points. In an exemplary embodiment, the other beam pattern is substantially trapezoidal in shape.

A lighting apparatus has been described which includes means for providing light, means for reflecting at least a portion of light from the means for providing light to produce a scallop beam pattern on a surface, and means for reflecting at least another portion of light from the means for providing light to produce another beam pattern on the surface, wherein the scallop beam pattern and the other beam pattern merge to form a wash beam pattern. In an exemplary embodiment, the wash beam pattern defines a boundary, the boundary defining a substantially continuous curve. In an exemplary embodiment, the substantially continuous curve is substantially free of inflection points. In an exemplary embodiment, the other beam pattern is substantially trapezoidal in shape.

A lighting apparatus has been described which includes a downlight cone defining a longitudinal axis and adapted to reflect at least a portion of light from a light source to produce a scallop beam pattern on a surface, a window defined by the downlight cone, the window including a first zone defining a first angle that ranges from about 90 degrees to about 130 degrees, the first angle lying on a first plane, a second zone defining a second angle that is about 180 degrees, the second angle lying on a second plane that is parallel to the first plane, wherein the vertices of the first and second angles lie on the longitudinal axis of the downlight cone, a pair of symmetric contours extending between the first and second zones, and an array of angles defined by the pair of symmetric contours, each angle in the array of angles being defined by a pair of symmetric points along the respective contours, each respective pair of points defining a directional distance between the points and the second zone that is parallel with the longitudinal axis of the downlight cone, wherein the size of each respective angle increases as each respective directional distance decreases, and a kicker reflector coupled to the downlight cone and positioned proximate the window and adapted to reflect at least another portion of light from the light source to produce a kicker beam pattern on the surface, the kicker beam pattern being substantially trapezoidal in shape, wherein the pair of symmetric contours at least partially defines the trapezoidal shape of the kicker beam pattern on the surface, and wherein the kicker beam pattern produced by the kicker reflector merges with the scallop beam pattern produced by the downlight cone to form a wash beam pattern defining a boundary, the boundary defining a substantially continuous curve that is substantially free of inflection points.

A method for providing light has been described which includes reflecting at least a portion of light from a light source to produce a scallop beam pattern on a surface, reflecting at least another portion of light from the light source to produce a trapezoidal beam pattern on the surface, and merging the scallop beam pattern and the trapezoidal beam pattern to form a wash beam pattern, wherein the wash beam pattern defines a boundary, the boundary defining a substantially continuous curve, whereby wherein the substantially continuous curve is substantially free of inflection points.

A lighting apparatus has been described which includes means for providing light, means for reflecting at least a portion of light from the means for providing light to produce a scallop beam pattern on a surface, and means for reflecting at least another portion of light from the means for providing light to produce a trapezoidal beam pattern on the surface, wherein the scallop beam pattern and the trapezoidal beam pattern merge to form a wash beam pattern, whereby the wash beam pattern defines a boundary, the boundary defining a substantially continuous curve which is substantially free of inflection points.

A lighting system has been described which includes a ceiling located adjacent a surface, and a plurality of lighting apparatus coupled to the ceiling and positioned proximate the surface, each lighting apparatus including a downlight cone comprising an inner reflective surface and defining a window, the window including a first zone defining a first angle and a second zone defining a second angle, a light source coupling device coupled to the downlight cone, and a kicker reflector coupled to the downlight cone and positioned proximate the window. In an exemplary embodiment, the second angle is greater than the first angle. In an exemplary embodiment, the first angle ranges from about 90 degrees to about 130 degrees. In an exemplary embodiment, the second angle is about 180 degrees. In an exemplary embodiment, the downlight cone defines a longitudinal axis upon which the vertices of the first and second angles lie, and wherein the first angle lies on a first plane and the second angle lies on a second plane that is parallel to the first plane. In an exemplary embodiment, the window further includes a pair of symmetric contours extending between the first and second zones. In an exemplary embodiment, a first pair of symmetric points along the respective contours defines a third zone defining a third angle that is greater than the first angle and less than the second angle. In an exemplary embodiment, a second pair of symmetric points along the respective contours defines a fourth zone positioned between the first zone and the third zone, the fourth zone defining a fourth angle that is greater than the first angle and less than the third angle. In an exemplary embodiment, a second pair of symmetric points along the respective contours defines a fourth zone positioned between the third zone and the second zone, the fourth zone defining a fourth angle that is greater than the third angle and less than the second angle. In an exemplary embodiment, the downlight cone defines a longitudinal axis upon which the vertices of the first and second angles lie, wherein the first angle lies on a first plane and the second angle lies on a second plane that is parallel to the first plane, wherein an array of angles is defined by the pair of symmetric contours, each angle in the array of angles being defined by a pair of symmetric points along the respective contours, each respective pair of points defining a directional distance between the points and the second zone that is parallel with the longitudinal axis, and wherein the size of each respective angle increases as each respective directional distance decreases. In an exemplary embodiment, the first angle ranges from about 90 degrees to about 130 degrees. In an exemplary embodiment, the second angle is about 180 degrees. In an exemplary embodiment, the kicker reflector is adapted to reflect at least a portion of light from a light source to produce a kicker beam pattern on a surface. In an exemplary embodiment, the window further includes a pair of symmetric contours extending between the first and second zones, wherein the pair of symmetric contours at least partially defines the shape of the kicker beam pattern on the surface. In an exemplary embodiment, the kicker beam pattern is substantially trapezoidal in shape. In an exemplary embodiment, the downlight cone is adapted to reflect at least another portion of light from the light source to produce a scallop beam pattern on the surface, and wherein the kicker beam pattern merges with the scallop beam pattern to form a wash beam pattern defining a boundary. In an exemplary embodiment, the boundary defined by the wash beam pattern defines a substantially continuous curve that is substantially free of inflection points.

A method for providing light has been described which includes providing a plurality of light sources positioned adjacent a surface, reflecting at least a portion of light from each light source to produce a plurality of scallop beam patterns on the surface, reflecting at least another portion of light from each light source to produce a plurality of other beam patterns on the surface, and merging the plurality of scallop beam patterns and the plurality of other beam patterns to form a plurality of wash beam patterns on the surface. In an exemplary embodiment, each of the wash beam patterns define a boundary, the boundary defining a substantially continuous curve. In an exemplary embodiment, the substantially continuous curve is substantially free of inflection points. In an exemplary embodiment, the plurality of other beam patterns are substantially trapezoidal in shape. In an exemplary embodiment, the method further comprises merging the plurality of wash beam patterns to uniformly light the surface.

A lighting apparatus has been described which includes means for providing a plurality of light sources, means for reflecting at least a portion of light from the means for providing a plurality of light sources to produce a plurality of scallop beam patterns on a surface, and means for reflecting at least another portion of light from the means for providing a plurality of light sources to produce a plurality of other beam patterns on the surface, wherein the plurality of scallop beam patterns and the plurality of other beam patterns merge to form a plurality of wash beam patterns. In an exemplary embodiment, the wash beam pattern defines a boundary, the boundary defining a substantially continuous curve. In an exemplary embodiment, the substantially continuous curve is substantially free of inflection points. In an exemplary embodiment, the other beam pattern is substantially trapezoidal in shape. In an exemplary embodiment, the plurality of wash beam patterns merge to uniformly light the surface.

A lighting apparatus has been described which includes a ceiling located adjacent a surface, and a plurality of lighting apparatus coupled to the ceiling and positioned proximate the surface, each lighting apparatus including a downlight cone defining a longitudinal axis and adapted to reflect at least a portion of light from a light source to produce a scallop beam pattern on the surface, a window defined by the downlight cone, the window including a first zone defining a first angle that ranges from about 90 degrees to about 130 degrees, the first angle lying on a first plane, a second zone defining a second angle that is about 180 degrees, the second angle lying on a second plane that is parallel to the first plane, wherein the vertices of the first and second angles lie on the longitudinal axis of the downlight cone, a pair of symmetric contours extending between the first and second zones, and an array of angles defined by the pair of symmetric contours, each angle in the array of angles being defined by a pair of symmetric points along the respective contours, each respective pair of points defining a directional distance between the points and the second zone that is parallel with the longitudinal axis of the downlight cone, wherein the size of each respective angle increases as each respective directional distance decreases, and a kicker reflector coupled to the downlight cone and positioned proximate the window and adapted to reflect at least another portion of light from the light source to produce a kicker beam pattern on the surface, the kicker beam pattern being substantially trapezoidal in shape, wherein the pair of symmetric contours at least partially defines the trapezoidal shape of the kicker beam pattern on the surface; and wherein the kicker beam pattern produced by the kicker reflector merges with the scallop beam pattern produced by the downlight cone to form a wash beam pattern defining a boundary, the boundary defining a substantially continuous curve that is substantially free of inflection points.

A method for providing light has been described which includes providing a plurality of light sources adjacent a surface, reflecting at least a portion of light from each light source to produce a plurality of scallop beam patterns on the surface, reflecting at least another portion of light from each light source to produce a plurality of trapezoidal beam patterns on the surface, merging the plurality of scallop beam patterns and the plurality of trapezoidal beam patterns to form a plurality of wash beam patterns on the surface, wherein each of the wash beam patterns define a boundary, the boundary defining a substantially continuous curve, whereby the substantially continuous curve is substantially free of inflection points, and merging the plurality of wash beam patterns to uniformly light the surface.

A lighting apparatus has been described which includes means for providing a plurality of light sources, means for reflecting at least a portion of light from the means for providing a plurality of light sources to produce a plurality of scallop beam patterns on a surface, means for reflecting at least another portion of light from, the means for providing a plurality of light sources to produce a plurality of trapezoidal beam patterns on the surface, wherein the plurality of scallop beam patterns and the plurality of trapezoidal beam patterns merge to form a plurality of wash beam patterns, whereby the wash beam pattern defines a boundary, the boundary defining a substantially continuous curve which is substantially free of inflection points, and whereby the plurality of wash beam patterns merge to uniformly light the surface.

A light providing apparatus has been described which includes a concave reflector comprising a reflector axis and defining a light source housing, and a light source coupling device coupled to the concave reflector and comprising a light source socket, whereby the light source socket is located in a spaced apart relationship from the reflector axis. In an exemplary embodiment, the concave reflector comprises a circular cross section. In an exemplary embodiment, the concave reflector comprises a top opening, whereby the light source socket is positioned such that the light source socket is located approximately halfway between the reflector axis and the top opening. In an exemplary embodiment, the concave reflector comprises a bottom opening, whereby the light source socket is positioned such that the light source socket is located approximately halfway between the reflector axis and the bottom opening. In an exemplary embodiment, the concave reflector comprises an arc tube top point, whereby the light source socket is positioned such that the light source socket is located approximately halfway between the reflector axis and the arc tube top point. In an exemplary embodiment, the concave reflector comprises an arc tube bottom point, whereby the light source socket is positioned such that the light source socket is located approximately halfway between the reflector axis and the arc tube bottom point. In an exemplary embodiment, the positioning of a light source in the light source socket results in an asymmetric light pattern upon operation of the light source. In an exemplary embodiment, the asymmetric light pattern comprises a light corner. In an exemplary embodiment, the concave reflector comprises a first side and a second side located on opposite sides of the concave reflector. In an exemplary embodiment, a first side reflector is coupled to the concave reflector. In an exemplary embodiment, an insert is coupled to the concave reflector. In an exemplary embodiment, a first side reflector is coupled to the concave reflector, and a plurality of inserts are coupled to the concave reflector. In an exemplary embodiment, with a light source positioned in the light socket, the apparatus provides a second side efficiency of light use from the light source in excess of 40%. In an exemplary embodiment, with a light source positioned in the light socket, the apparatus provides a second side efficiency of light use from the light source of approximately 43%. In an exemplary embodiment, with a light source positioned in the light socket, the apparatus provides a total efficiency of light use from the light source in excess of 65%. In an exemplary embodiment, with a light source positioned in the light socket, the apparatus provides a total efficiency of light use from the light source of approximately 67%. In an exemplary embodiment, a light source is coupled to the light source socket. In an exemplary embodiment, the concave reflector comprises an imaginary disk with its center on the reflector axis and intersecting the arc tube at the arc tube top point, whereby the light source socket is located approximately halfway between the reflector axis and the edge of the imaginary disk. In an exemplary embodiment, the concave reflector comprises an imaginary disk with its center on the reflector axis and intersecting thee arc tube at the arc tube bottom point, whereby the light source socket is located approximately halfway between the reflector axis and the edge of the imaginary disk.

A method for providing light has been described which includes positioning a light providing apparatus adjacent a surface comprising a first side and a second side, and providing an asymmetrical light pattern on the surface with the light providing apparatus. In an exemplary embodiment, the providing an asymmetrical light pattern comprises a first side light contribution which is substantially larger than a second side light contribution. In an exemplary embodiment, the providing an asymmetrical light pattern comprises a light corner. In an exemplary embodiment, the providing an asymmetrical light pattern comprises a first side efficiency of light use from light source in excess of 40%. In an exemplary embodiment, the providing an asymmetrical light pattern comprises a first side efficiency of light use from the light source of approximately 43%. In an exemplary embodiment, the providing an asymmetrical light pattern comprises providing a light pattern comprising a total efficiency of light use from the light source in excess of 65%. In an exemplary embodiment, the providing an asymmetrical light pattern comprises providing a light pattern comprising a total efficiency of light use from the light source of approximately 67%.

A light providing apparatus has been described which includes means for providing light, and means for providing an asymmetrical light pattern with the means for providing light. In an exemplary embodiment, the means for providing an asymmetrical light pattern comprises a first side and a second side, whereby the means for providing an asymmetrical light pattern provides a first side light contribution from the means for providing light which is substantially larger than a second side light contribution from the means for providing light. In an exemplary embodiment, the means for providing an asymmetrical light pattern provides a light corner from the means for providing light. In an exemplary embodiment, the means for providing an asymmetrical light pattern comprises a first side and a second side, whereby the means for providing an asymmetrical light pattern provides a first side efficiency of light use from the mean for providing light in excess of 40%. In an exemplary embodiment, the means for providing an asymmetrical light pattern comprises a first side and a second side, whereby the means for providing an asymmetrical light pattern provides a first side efficiency of light use from the means for providing light of approximately 43%. In an exemplary embodiment, the means for providing an asymmetrical light pattern comprises a first side and a second side, whereby the means for providing an asymmetrical light pattern provides a total efficiency of light use from the means for providing light in excess of 65%. In an exemplary embodiment, the means for providing an asymmetrical light pattern provides a total efficiency of light use from the means for providing light of approximately 67%.

A light providing apparatus has been described which includes a concave reflector comprising a reflector axis, a top opening, and defining a light source housing, a house side reflector coupled to the concave reflector and located in the light source housing, a insert coupled to the concave reflector and located in the light source housing, and a light source comprising a light source axis and located in the light source housing between a center of curvature of the concave reflector and the concave reflector, whereby the light source axis is located in a spaced apart relationship from the reflector axis approximately halfway between the reflector axis and the top opening such that the reflector axis and the light source axis are substantially parallel, wherein the positioning of the light source in the light source housing results in an asymmetric light pattern upon operation of the light source.

A light providing apparatus has been described which includes a concave reflector comprising a reflector axis, a bottom opening, and defining a light source housing, a house side reflector coupled to the concave reflector and located in the light source housing, a insert coupled to the concave reflector and located in the light source housing, and a light source comprising a light source axis and located in the light source housing between a center of curvature of the concave reflector and the concave reflector, whereby the light source axis is located in a spaced apart relationship from the reflector axis approximately halfway between the reflector axis and the bottom opening such that the reflector axis and the light source axis are substantially parallel, wherein the positioning of the light source in the light source housing results in an asymmetric light pattern upon operation of the light source.

A light providing apparatus has been described which includes a concave reflector comprising a reflector axis, an arc tube top point, and defining a light source housing, a house side reflector coupled to the concave reflector and located in the light source housing, a insert coupled to the concave reflector and located in the light source housing, and a light source comprising a light source axis and located in the light source housing between a center of curvature of the concave reflector and the concave reflector, whereby the light source axis is located in a spaced apart relationship from the reflector axis approximately halfway between the reflector axis and the arc tube top point such that the reflector axis and the light source axis are substantially parallel, wherein the positioning of the light source in the light source housing results in an asymmetric light pattern upon operation of the light source.

A light providing apparatus has been described which includes a concave reflector comprising a reflector axis, an arc tube bottom point, and defining a light source housing, a house side reflector coupled to the concave reflector and located in the light source housing, a insert coupled to the concave reflector and located in the light source housing, and a light source comprising a light source axis and located in the light source housing between a center of curvature of the concave reflector and the concave reflector, whereby the light source axis is located in a spaced apart relationship from the reflector axis approximately halfway between the reflector axis and the arc tube bottom point such that the reflector axis and the light source axis are substantially parallel, wherein the positioning of the light source in the light source housing results in an asymmetric light pattern upon operation of the light source.

A method for providing light has been described which includes positioning a light providing apparatus adjacent a surface comprising a first side and a second side, providing an asymmetrical light pattern on the surface with the light providing apparatus, wherein the providing an asymmetrical light pattern comprises a first side light contribution which is substantially larger than a second side light contribution, a light corner, a first side efficiency of light use from light source of approximately 43%, and a total efficiency of light use from the light source of approximately 67%.

A light providing apparatus has been described which includes means for providing light, and means for providing an asymmetrical light pattern with the means for providing light, wherein the means for providing an asymmetrical light pattern comprises a first side and a second side, whereby the means for providing an asymmetrical light pattern provides a first side light contribution from the means for providing light which is substantially larger than a second side light contribution from the means for providing light, and the means for providing an asymmetrical light pattern provides a light corner from the means for providing light, whereby the means for providing an asymmetrical light pattern provides a first side efficiency of light use from the means for providing light of approximately 43% and a total efficiency of light use from the means for providing light of approximately 67%.

It is understood that variations may be made in the foregoing without departing from the scope of the disclosure.

Any foregoing spatial references such as, for example, “upper,” “lower,” “above,” “below,” “rear,” “between,” “vertical,” “angular,” etc., are for the purpose of illustration only and do not limit the specific orientation or location of the structure described above.

In several exemplary embodiments, it is understood that one or more of the operational steps in each embodiment may be omitted. Moreover, in some instances, some features of the present disclosure may be employed without a corresponding use of the other features. Moreover, it is understood that one or more of the above-described embodiments and/or variations may be combined in whole or in part with any one or more of the other above-described embodiments and/or variations.

Although exemplary embodiments of this disclosure have been described in detail above, those skilled in the art will readily appreciate that many other modifications, changes and/or substitutions are possible in the exemplary embodiments without materially departing from the novel teachings and advantages of this disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

What is claimed is:

1. A lighting apparatus, comprising:
a downlight cone comprising an inner reflective surface and defining a window, the window comprising:
a first zone defining a first angle, and
a second zone defining a second angle.

2. The apparatus of claim 1, wherein the second angle is greater than the first angle.

3. The apparatus of claim 2, wherein the first angle ranges from about 90 degrees to about 130 degrees.

4. The apparatus of claim 2, wherein the second angle is about 180 degrees.

5. The apparatus of claim 2, wherein the downlight cone defines a longitudinal axis upon which the vertices of the first and second angles lie; and
wherein the first angle lies on a first plane and the second angle lies on a second plane that is parallel to the first plane.

6. The apparatus of claim 2, wherein the window further comprises:
a pair of symmetric contours extending between the first and second zones.

7. The apparatus of claim 6, wherein a first pair of symmetric points along the respective contours defines a third zone defining a third angle that is greater than the first angle and less than the second angle.

8. The apparatus of claim 7, wherein a second pair of symmetric points along the respective contours defines a fourth zone positioned between the first zone and the third zone, the fourth zone defining a fourth angle that is greater than the first angle and less than the third angle.

9. The apparatus of claim 7, wherein a second pair of symmetric points along the respective contours defines a fourth zone positioned between the third zone and the second zone, the fourth zone defining a fourth angle that is greater than the third angle and less than the second angle.

10. A lighting apparatus, comprising:
a downlight cone defining a longitudinal axis and adapted to reflect at least a portion of light from a light source to produce a scallop beam pattern on a surface;
a window defined by the downlight cone, the window comprising:
a first zone defining a first angle that ranges from about 90 degrees to about 130 degrees, the first angle lying on a first plane;
a second zone defining a second angle that is about 180 degrees, the second angle lying on a second plane that is parallel to the first plane, wherein the vertices of the first and second angles lie on the longitudinal axis of the downlight cone;
a pair of symmetric contours extending between the first and second zones, and
an array of angles defined by the pair of symmetric contours, each angle in the array of angles being defined by a pair of symmetric points along the respective contours, each respective pair of points defining a directional distance between the points and the second zone that is parallel with the longitudinal axis of the downlight cone, wherein the size of each respective angle increases as each respective directional distance decreases.

11. A lighting apparatus, comprising:
a downlight cone comprising an inner reflective surface and defining a window, the window comprising:
a first zone defining a first angle, and
a second zone defining a second angle;
a light source coupling device coupled to the downlight cone; and
a kicker reflector coupled to the downlight cone and positioned proximate the window.

12. The apparatus of claim 11, wherein the second angle is greater than the first angle.

13. The apparatus of claim 12, wherein the first angle ranges from about 90 degrees to about 130 degrees.

14. The apparatus of claim 12, wherein the second angle is about 180 degrees.

15. The apparatus of claim 12, wherein the downlight cone defines a longitudinal axis upon which the vertices of the first and second angles lie; and
wherein the first angle lies on a first plane and the second angle lies on a second plane that is parallel to the first plane.

16. The apparatus of claim 12, wherein the window further comprises:
a pair of symmetric contours extending between the first and second zones.

17. The apparatus of claim 16, wherein a first pair of symmetric points along the respective contours defines a third zone defining a third angle that is greater than the first angle and less than the second angle.

18. The apparatus of claim 17, wherein a second pair of symmetric points along the respective contours defines a fourth zone positioned between the first zone and the third zone, the fourth zone defining a fourth angle that is greater than the first angle and less than the third angle.

19. The apparatus of claim 17, wherein a second pair of symmetric points along the respective contours defines a fourth zone positioned between the third zone and the second zone, the fourth zone defining a fourth angle that is greater than the third angle and less than the second angle.

20. The apparatus of claim 11, wherein the kicker reflector is adapted to reflect at least a portion of light from a light source to produce a kicker beam pattern on a surface.

21. The apparatus of claim 20 wherein the window further comprises:
a pair of symmetric contours extending between the first and second zones;
wherein the pair of symmetric contours at least partially defines the shape of the kicker beam pattern on the surface.

22. The apparatus of claim 20, wherein the kicker beam pattern is substantially trapezoidal in shape.

23. The apparatus of claim 20, wherein the downlight cone is adapted to reflect at least another portion of light from a light source to produce a scallop beam pattern on the surface, and wherein the kicker beam pattern merges with the scallop beam pattern to form a wash beam pattern defining a boundary.

24. The apparatus of claim 23, wherein the boundary defined by the wash beam pattern defines a substantially continuous curve that is substantially free of inflection points.

25. A lighting apparatus, comprising:
a downlight cone defining a longitudinal axis and adapted to reflect at least a portion of light from a light source to produce a scallop beam pattern on a surface;
a window defined by the downlight cone, the window comprising:
a first zone defining a first angle that ranges from about 90 degrees to about 130 degrees, the first angle lying on a first plane;
a second zone defining a second angle that is about 180 degrees, the second angle lying on a second plane that is parallel to the first plane, wherein the vertices of the first and second angles lie on the longitudinal axis of the downlight cone;
a pair of symmetric contours extending between the first and second zones, and
an array of angles defined by the pair of symmetric contours, each angle in the array of angles being defined by a pair of symmetric points along the respective contours, each respective pair of points defining a directional distance between the points and the second zone that is parallel with the longitudinal axis of the downlight cone, wherein the size of each respective angle increases as each respective directional distance decreases; and
a kicker reflector coupled to the downlight cone and positioned proximate the window and adapted to reflect at least another portion of light from the light source to produce a kicker beam pattern on the surface, the kicker beam pattern being substantially trapezoidal in shape;
wherein the pair of symmetric contours at least partially defines the trapezoidal shape of the kicker beam pattern on the surface; and
wherein the kicker beam pattern produced by the kicker reflector merges with the scallop beam pattern produced by the downlight cone to form a wash beam pattern defining a boundary, the boundary defining a substantially continuous curve that is substantially free of inflection points.

26. A lighting system, comprising:
a ceiling located adjacent a surface; and
a plurality of lighting apparatus coupled to the ceiling and positioned proximate the surface, each lighting apparatus comprising:
a downlight cone comprising an inner reflective surface and defining a window, the window comprising:
a first zone defining a first angle, and
a second zone defining a second angle;
a light source coupling device coupled to the downlight cone; and
a kicker reflector coupled to the downlight cone and positioned proximate the window.

27. The system of claim 26, wherein the second angle is greater than the first angle.

28. The system of claim 27, wherein the first angle ranges from about 90 degrees to about 130 degrees.

29. The system of claim 27, wherein the second angle is about 180 degrees.

30. The system of claim 27, wherein the downlight cone defines a longitudinal axis upon which the vertices of the first and second angles lie; and
wherein the first angle lies on a first plane and the second angle lies on a second plane that is parallel to the first plane.

31. The system of claim 27, wherein the window further comprises:
a pair of symmetric contours extending between the first and second zones.

32. The system of claim 31, wherein a first pair of symmetric points along the respective contours defines a third zone defining a third angle that is greater than the first angle and less than the second angle.

33. The system of claim 32, wherein a second pair of symmetric points along the respective contours defines a fourth zone positioned between the first zone and the third zone, the fourth zone defining a fourth angle that is greater than the first angle and less than the third angle.

34. The system of claim 32, wherein a second pair of symmetric points along the respective contours defines a fourth zone positioned between the third zone and the second zone, the fourth zone defining a fourth angle that is greater than the third angle and less than the second angle.

35. The system of claim 26, wherein the kicker reflector is adapted to reflect at least a portion of light from a light source to produce a kicker beam pattern on a surface.

36. The system of claim 35 wherein the window further comprises:
a pair of symmetric contours extending between the first and second zones;
wherein the pair of symmetric contours at least partially defines the shape of the kicker beam pattern on the surface.

37. The system of claim 26, wherein the downlight cone is adapted to reflect at least another portion of light from the light source to produce a scallop beam pattern on the surface, and wherein the kicker beam pattern merges with the scallop beam pattern to form a wash beam pattern defining a boundary.

38. The system of claim 37, wherein the boundary defined by the wash beam pattern defines a substantially continuous curve that is substantially free of inflection points.

39. A lighting apparatus, comprising:
a ceiling located adjacent a surface; and
a plurality of lighting apparatus coupled to the ceiling and positioned proximate the surface, each lighting apparatus comprising:
a downlight cone defining a longitudinal axis and adapted to reflect at least a portion of light from a light source to produce a scallop beam pattern on the surface;
a window defined by the downlight cone, the window comprising:
a first zone defining a first angle that ranges from about 90 degrees to about 130 degrees, the first angle lying on a first plane;
a second zone defining a second angle that is about 180 degrees, the second angle lying on a second plane that is parallel to the first plane, wherein the vertices of the first and second angles lie on the longitudinal axis of the downlight cone;
a pair of symmetric contours extending between the first and second zones, and
an array of angles defined by the pair of symmetric contours, each angle in the array of angles being defined by a pair of symmetric points along the respective contours, each respective pair of points defining a directional distance between the points and the second zone that is parallel with the longitudinal axis of the downlight cone, wherein the size of each respective angle increases as each respective directional distance decreases; and
a kicker reflector coupled to the downlight cone and positioned proximate the window and adapted to reflect at least another portion of light from the light source to produce a kicker beam pattern on the surface, the kicker beam pattern being substantially trapezoidal in shape;
wherein the pair of symmetric contours at least partially defines the trapezoidal shape of the kicker beam pattern on the surface; and
wherein the kicker beam pattern produced by the kicker reflector merges with the scallop beam pattern produced by the downlight cone to form a wash beam pattern defining a boundary, the boundary defining a substantially continuous curve that is substantially free of inflection points.
